(19) United States
(12) Patent Application Publication
(10) Pub. No.: US 2026/0289176 A1
(43) Pub. Date: Sep. 24, 2026

(54) SYSTEM

(71) Applicant: SoftBank Group Corp., Tokyo (JP)

(72) Inventor: Koichi NOMURA, Tokyo (JP)

(73) Assignee: SoftBank Group Corp., Tokyo (JP)

(21) Appl. No.: 19/565,571

(22) Filed: Mar. 13, 2026

(30) Foreign Application Priority Data
Mar. 19, 2025 (JP) 2025-045052

(51) Int. Cl. G06F 40/40; G06F 16/93; G06F 40/103; G06F 40/186; G06F 40/205; G06F 40/268; G06F 40/284; G06F 40/289; G06N 3/0475; G06V 10/82

(52) U.S. Cl. CPC G06F 40/40; G06F 16/93; G06F 40/103; G06F 40/186; G06F 40/205; G06F 40/268; G06F 40/284; G06F 40/289; G06V 10/82; G06N 3/0475

(57) ABSTRACT

A system includes a processor that is configured to receive a search request from a user, collect information sources relevant to the received search request, analyze the collected information sources using a generative AI model and extract a summary from the information sources, identify important phrases from the summary and generate identifiers based on the important phrases, and transmit the generated identifiers to a terminal of the user.

### CROSS-REFERENCE TO RELATED APPLICATION

This application is based on and claims priority under 35 USC 119 from Japanese Patent Application No. 2025-045052 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information retrieval systems and e-commerce systems typically present search results or product information as lists of titles, short descriptions, or raw metadata. In such systems, a user is required to read multiple texts or inspect multiple pages in order to understand the essential content or characteristics of each information source or product. As the volume and diversity of available information sources and products increase, this imposes a significant cognitive burden on the user and degrades the overall user experience. Furthermore, conventional systems do not effectively utilize generative AI models to summarize and structurally represent information in a form that can be quickly grasped by the user, such as concise identifiers derived from important phrases. In addition, prompts used for generative AI models in existing systems are often ad hoc and are not systematically designed to generate identifiers or to propose related information in a consistent and controllable manner. Therefore, there is a need for a system that can automatically analyze information sources and product information by using a generative AI model, extract a summary, identify important phrases from the summary, generate identifiers based on the important phrases, and provide these identifiers and related information to a user terminal in order to improve search efficiency, information comprehension, and navigation.

### SUMMARY

In order to solve the above-described problem, according to one aspect, there is provided a system comprising a processor, wherein the processor is configured to receive a search request from a user, collect information sources relevant to the received search request, analyze the collected information sources using a generative AI model, and extract a summary from the information sources. The processor is further configured to identify important phrases from the summary, generate identifiers based on the important phrases, and transmit the generated identifiers to a terminal of the user. In one embodiment, the processor is configured to analyze product information and characters and images contained in the information sources, and to use a prompt for instructing the generative AI model to generate the identifiers and to cause display of the identifiers. In another embodiment, the processor is configured to use a prompt for instructing the generative AI model to propose related information to the user based on information analyzed by the generative AI model. By employing these configurations, the system can utilize the generative AI model under explicit prompt control to generate concise identifiers and related information from complex text and image data, and to provide them to the user terminal in a structured manner, thereby reducing the cognitive load on the user and improving usability and user experience.

The term “system” refers to an apparatus or combination of apparatuses including at least one processor and, as applicable, memory, communication interfaces, and other hardware or software components that cooperate to perform the claimed functions. The term “processor” refers to any hardware component or set of components capable of executing instructions, such as a central processing unit (CPU), graphics processing unit (GPU), microcontroller, application specific integrated circuit (ASIC), field programmable gate array (FPGA), or a combination thereof.

The term “search request” refers to information input by a user, including but not limited to keywords, phrases, queries, or filter conditions, that specifies a subject or scope for which relevant information sources are to be retrieved.
The term “user” refers to a human operator or an entity acting on behalf of a human who interacts with the system to issue search requests, receive identifiers, and consume proposed related information.
The term “information source” refers to any source of data or content, including but not limited to web pages, documents, product records, databases, images, or multimedia content, from which information can be retrieved and analyzed.
The term “collect information sources relevant to the received search request” refers to obtaining, retrieving, or selecting one or more information sources that satisfy a condition related to the content or parameters of the search request, by using, for example, a search engine, index, or database query.
The term “generative AI model” refers to a machine learning model, such as a neural network model, configured to generate text, summaries, or other outputs based on input data, including but not limited to large language models and multimodal generative models.
The term “analyze the collected information sources using a generative AI model” refers to processing the content of the collected information sources with the generative AI model so as to derive structured information, such as summaries, key phrases, or semantic representations.
The term “summary” refers to a condensed representation of the content of one or more information sources, generated by the generative AI model, that contains essential information in a shorter form than the original content.
The term “identify important phrases from the summary” refers to detecting, selecting, or extracting phrases or word sequences within the summary that are determined, by predetermined rules or model output, to be particularly representative or significant for characterizing the content.
The term “identifier” refers to a string, token, tag, hashtag, label, or other symbolic expression generated based on one or more important phrases, which serves to concisely represent or categorize the content of the corresponding information source.
The term “generate identifiers based on the important phrases” refers to creating one or more identifiers by transforming, formatting, or otherwise processing the important phrases, for example by normalization, concatenation, or addition of a prefix.
The term “terminal of the user” refers to any device operated directly or indirectly by the user, such as a personal computer, smartphone, tablet, or other client device, that is capable of communicating with the system and displaying or otherwise outputting information.
The term “transmit the generated identifiers to a terminal of the user” refers to sending data representing the identifiers from the system to the user's terminal via a communication network or interface so that the terminal can output or display the identifiers.
The term “product information” refers to data that describe a product, including but not limited to product names, specifications, descriptions, attributes, prices, categories, and associated media such as images.
The term “characters and images contained in the information sources” refers to textual elements such as letters, numbers, and symbols, and visual elements such as photographs, illustrations, or graphics that are included within the information sources.
The term “prompt” refers to a text or structured input provided to the generative AI model that specifies or constrains the behavior of the model, including instructions or conditions for generating identifiers or proposing related information.
The term “use a prompt for instructing the generative AI model to generate the identifiers and to cause display of the identifiers” refers to supplying the generative AI model with a prompt that directs the model to output content usable as identifiers and to output or specify information for their presentation or display to the user.
The term “related information” refers to information that is associated with, relevant to, or inferred from the analyzed information sources or product information, such as similar items, recommended content, additional explanations, or links.
The term “propose related information to the user” refers to presenting, recommending, or suggesting one or more pieces of related information to the user, for example by including such information in a response transmitted to the user's terminal.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

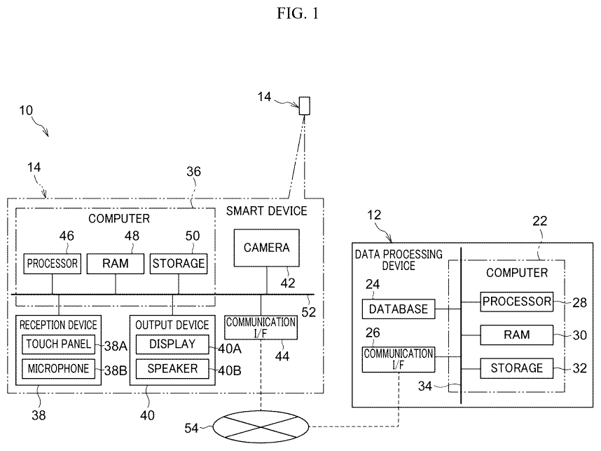

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

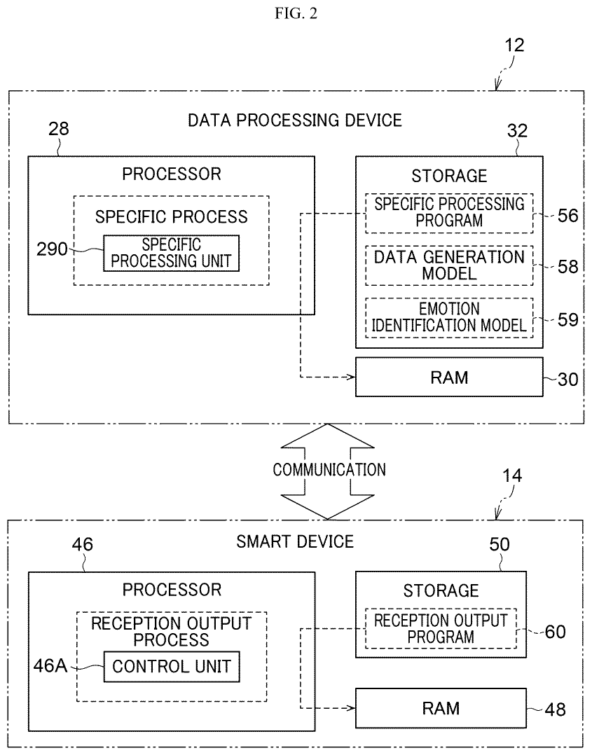

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information retrieval systems typically present search results as lists of titles and short snippets generated by a simple ranking engine. Such systems require a user to open and manually review multiple information sources to understand the actual content of each source. This leads to significant cognitive load and inefficient navigation, particularly when information sources are long-form documents, complex product descriptions, or heterogeneous resources including text and images.

Moreover, existing systems that attempt to summarize or categorize information sources often rely on static keyword extraction or rule-based techniques. These techniques operate on a limited representation of the document and do not exploit advanced natural language understanding capabilities. As a result, the generated labels or categories are frequently generic, redundant, or poorly aligned with the user's actual decision-making needs. Users still need to spend substantial time interpreting results before they can identify truly relevant information.
In addition, when a generative artificial intelligence model is used in a naive manner, such as directly feeding raw document text into the model without structured prompt design or preprocessing, there are several technical problems. The model output can be unstable, overly verbose, and inconsistent across similar inputs. The lack of standardized prompt sentences, text normalization, and result post-processing yields outputs that are not machine-actionable or usable as structured identifiers. This undermines the ability of the information retrieval system to perform programmatic filtering, ranking, or UI-level interactions based on the generated content.
From a computer technology perspective, existing search architectures do not adequately integrate generative artificial intelligence models into the retrieval pipeline as a first-class processing component. The systems do not:
(1) systematically preprocess source texts to fit constraints of generative models and stabilize their behavior;
(2) construct consistent, machine-readable prompt sentences that drive the model toward concise, label-like outputs; and
(3) transform the model outputs into structured, deduplicated identifiers that can be used as indexable and interactive metadata for each information source.
   Consequently, user interfaces cannot efficiently exploit generative model outputs to provide intuitive, identifier-based navigation and filtering. The search engine backend cannot reliably associate identifiers with individual information sources in a structured, queryable form. This results in increased server-side processing overhead, inconsistent results, and an inability to offer a differentiated, high-efficiency narrowing and navigation experience.
   Therefore, there is a need for a computer-implemented technique that technically improves the functioning of an information retrieval system by tightly integrating a generative artificial intelligence model into the retrieval and post-processing stages. The technique should generate consistent, structured identifiers from arbitrary information sources, and expose these identifiers to a user terminal in such a way that the terminal can render them as interactive labels that support rapid understanding, narrowing, and navigation. Such a solution should improve the efficiency and reliability of search result processing, reduce user interaction cost, and enhance the overall performance of the computing system that executes the search and presentation operations.

The specific processing by the specific processing unit 290 of the data processing device 12 in Example 1 is realized by the following means.

The present invention provides a server comprising a processor configured to receive, from a user terminal via a communication network, a search request, to obtain candidate information sources by causing an external information retrieval mechanism to perform search processing based on the search request, to acquire document data corresponding to the candidate information sources, to analyze structured documents included in the document data to extract main text information, to perform preprocessing on the extracted text information including character normalization and trimming based on a length limit, to generate a prompt sentence in natural language for inputting the preprocessed text information to a generative artificial intelligence model, to input the generated prompt sentence and the preprocessed text information to the generative artificial intelligence model and obtain a summary or important information of the text information by language model processing including tokenization and an attention mechanism, to extract, based on the summary or important information, a plurality of terms or term sequences, to convert the terms or term sequences by format conversion into an array of identifiers as labels and arrange the identifiers by duplicate elimination and limitation on a number of identifiers, to generate structured data by associating the arranged identifiers with each of the candidate information sources, and to transmit the structured data as search results to the user terminal together with display control information that causes titles, summary information, and the identifiers to be displayable and selectable on the user terminal. This enables a computer system to integrate a generative artificial intelligence model into the search pipeline in a structured manner, to transform unstructured document content into stable, machine-actionable identifiers, and to provide an improved search interface that allows the user terminal to perform efficient identifier-based narrowing and navigation, thereby reducing computational redundancy, enhancing relevance of retrieved results, and improving overall performance and usability of the information retrieval system.

The term “processor” refers to a hardware computation unit or a combination of hardware computation units, such as one or more central processing units or one or more processing cores, that executes instructions of a program to perform the described operations.

The term “user terminal” refers to an information processing apparatus operated by a user, including but not limited to a mobile device, a personal computer, or another client device, that communicates with a server via a communication network.
The term “communication network” refers to a wired or wireless data transmission infrastructure, such as a local area network, a wide area network, or a packet-switched network, through which data is exchanged between the server and the user terminal.
The term “search request” refers to electronic query information, including at least one query string or condition, transmitted from the user terminal to the server for the purpose of retrieving relevant information sources.
The term “external information retrieval mechanism” refers to a software-controlled information retrieval system, such as a search engine or an index server, that receives a search query and outputs one or more information sources deemed relevant to the search query.
The term “candidate information sources” refers to a plurality of digital resources, such as documents, web pages, or data records, obtained from the external information retrieval mechanism as potentially relevant to the search request.
The term “document data” refers to digital data representing the contents of an information source, including at least structured data such as markup documents, metadata, and associated text segments.
The term “structured document” refers to a document expressed in a machine-parsable structure, such as a markup document, that includes elements or tags indicating logical structure, regions, or formatting of content.
The term “main text information” refers to a portion of textual content extracted from a structured document that represents primary substantive content of an information source, excluding navigation elements, decorative text, or ancillary content.
The term “preprocessing” refers to a series of operations performed on text information before input to a generative artificial intelligence model, including normalization, filtering, and length adjustment, in order to satisfy model constraints and stabilize model behavior.
The term “character normalization” refers to processing that unifies character encodings and representations, including conversion of character sets, standardization of punctuation, and normalization of whitespace, to yield a consistent text format.
The term “trimming based on a length limit” refers to processing that limits the amount of text by removing or truncating a portion of the text when the length of the text exceeds a predetermined threshold.
The term “prompt sentence” refers to a natural language instruction or set of instructions that is constructed to guide a generative artificial intelligence model to perform a specified task on given input data.
The term “generative artificial intelligence model” refers to a machine learning model configured to generate or transform natural language text based on input text and instructions, and that uses probabilistic or neural computation to produce outputs.
The term “natural language processing” refers to computational techniques for analyzing, interpreting, or generating human language text by means of algorithms, statistical models, or machine learning models.
The term “language model processing” refers to processing performed by a language model that estimates, generates, or transforms sequences of linguistic units, and may include internal operations such as tokenization and attention-based computation.
The term “tokenization” refers to a process that segments input text into smaller units, such as words, subword units, or symbols, that serve as atomic units for processing by a language model.
The term “attention mechanism” refers to a computational technique within a model architecture that assigns variable weights to different parts of input sequences, enabling the model to focus on relevant portions of the input when generating or analyzing outputs.
The term “summary” refers to condensed text representing essential content of a larger text, produced in a form shorter than the original while preserving key information.
The term “important information” refers to specific elements of content, such as key concepts, salient facts, or representative phrases, determined by the system or model to be relevant for characterizing an information source.
The term “term” refers to a unit of text, such as a word or phrase, that expresses a concept or topic included in text information.
The term “term sequence” refers to a plurality of terms arranged in a specific order, forming a phrase or multi-word expression that collectively represents a concept or topic.
The term “format conversion” refers to transformation of text or data from one representation to another representation, such as adding prefixes, replacing spaces, or normalizing case, to produce identifiers suitable for machine handling or display.
The term “identifier” refers to a textual label derived from a term or term sequence and transformed into a consistent format, used to represent or classify the content of an information source in a machine-readable manner.
The term “label” refers to a descriptor presented as a textual element, such as an identifier, that expresses a category, topic, or characteristic associated with an information source.
The term “array of identifiers” refers to an ordered or indexed collection of multiple identifiers associated with an information source.
The term “duplicate elimination” refers to processing that detects and removes identifiers that are equivalent or substantially similar within an array of identifiers to avoid redundancy.
The term “limitation on a number of identifiers” refers to processing that restricts the total count of identifiers associated with an information source to a predetermined maximum number.
The term “structured data” refers to data organized according to a predetermined schema or format, such as a record or object including fields that represent attributes of information sources and associated identifiers.
The term “search results” refers to data transmitted from the server to the user terminal that represents one or more candidate information sources selected or ranked in response to a search request.
The term “display control information” refers to data that defines or influences how content, including titles, summary information, and identifiers, is to be rendered or made interactively available on a user terminal.
The term “titles” refers to textual elements that denote names or headings of information sources, suitable for presentation as clickable or selectable entries in a user interface.
The term “summary information” refers to text that concisely represents the content of an information source and is used to provide a brief overview to a user in a search result display.
The term “selection operation” refers to an input action performed by a user, such as a click, tap, or other user interface interaction, that indicates a choice of one or more identifiers or other displayed elements.
The term “narrowing of the search results” refers to processing that filters or restricts a set of search results based on one or more conditions, such as selected identifiers, to output a subset of the original search results.
The term “transition to one of the information sources” refers to an operation that causes the user terminal to access or display an information source, such as by opening a document, web page, or detailed view corresponding to a selected search result.
The term “product-related data” refers to information describing goods or services, including attributes, specifications, features, prices, or other product characteristics.
The term “character information” refers to information represented as textual characters, including alphanumeric strings and symbols, contained in an information source.
The term “image-related information” refers to information that describes or is associated with image content, including image captions, alternative text, metadata, or extracted text from images.
The term “visually recognizable label format” refers to a representation of identifiers suitable for display on a user interface in a manner that distinguishes them visually, such as by specific styling, delimitation, or emphasis.
The term “labels or short sentences” refers to concise textual elements, including brief descriptors or short natural language expressions, that summarize or characterize content for purposes such as recommendation or navigation.
The term “additional information” refers to information not explicitly requested in the original search request but determined to be relevant to a user based on analysis of information sources, such as related topics or supplemental resources.
The term “candidate products” refers to goods or services suggested to a user based on relevance inferred from analyzed content, such as alternative items, comparable items, or complementary items.
The term “related information sources” refers to information sources that are associated with or similar to a current information source or search context, identified as being relevant for recommendation or further exploration.

In one embodiment, a server includes a processor, a memory, a non-transitory storage device, and a network interface, all interconnected via a system bus. The server executes an operating system such as a general-purpose server operating system and application software that implements the information retrieval and identifier generation functions described herein.

The server communicates with one or more terminals operated by users through a communication network such as the Internet. Each terminal includes a display, an input interface, and a communication interface, and runs client software such as a web browser or a native application.
The server uses a program stored in the non-transitory storage device and loaded into the memory to perform information retrieval, natural language processing, and structured identifier generation. The program is implemented, for example, as a web application written in a high-level language running on a runtime environment or application server. The server also interacts with an external information retrieval mechanism, such as a search engine or index server, via an application programming interface.
The server analyzes document data returned from the external information retrieval mechanism by parsing structured documents such as markup documents. The server uses a document parsing component that employs a markup parsing library (for instance, a library functionally similar to a tree-based parser) to construct a document object model in memory.
The server removes predefined classes of elements that are not relevant to main content, such as navigation bars, style elements, scripts, or advertisement containers, and extracts main text information by selecting nodes that satisfy predefined heuristics, such as node depth, text length, and tag type. In this way, the server isolates primary textual content that is most useful for subsequent processing.
The server then performs preprocessing on the main text information prior to supplying it to a generative AI model. The server stores the text in a normalized internal representation, for example in a Unicode character set, and applies character normalization operations such as converting full-width characters to half-width characters, unifying different quotation marks, and removing non-printable control characters. The server also performs length-based trimming by measuring the number of characters or approximate tokens and discarding trailing segments beyond a configurable threshold so that the input size conforms to the token capacity of the generative AI model. These preprocessing steps reduce memory usage and improve the determinism of the model output.
The server generates a prompt sentence for the generative AI model by combining a predefined instruction template with the preprocessed text. The prompt sentence is a natural language instruction specifically tailored to control the behavior of the model. In one embodiment, the server constructs a prompt sentence of the following form:
“From the following web page text, extract 5-10 important keywords that represent the main topics, and output them only as identifiers in hashtag format (e.g., #keyword). Use concise English terms, no explanations. Text: [TEXT]”
   In another embodiment, the server uses a more constrained prompt sentence such as:
“Read the text below and list short topic labels as hashtags. Do not output sentences. Do not output anything other than hashtags. Limit to 8 hashtags. Text: [TEXT]”
   In yet another embodiment, when product-related information is expected, the server generates a prompt sentence such as:
“From the following product description and review text, extract 5-10 technical and product-related keywords that would help a user filter search results. Output them as English hashtags, such as #battery_life or #camera_performance. Text: [TEXT]”
   The server inserts the preprocessed text into the placeholder [TEXT] after optionally truncating the text to prevent exceeding a token limit. By using such structured prompt sentences, the server constrains the generative AI model to produce compact, label-like outputs instead of free-form summaries. This control is not achievable by a human operator in real time at the scale of many documents and leads to consistent machine-actionable output that directly improves downstream computer processing.
   The server employs a generative AI model implemented as a neural network, for example a transformer-based language model. The model includes an embedding layer that converts tokens into vector representations, a plurality of attention-based layers that compute context-aware representations using multi-head self-attention and feed-forward sublayers, and an output layer that predicts a probability distribution over possible next tokens. The server uses a tokenizer that segments the prompt sentence and the preprocessed text into subword tokens according to a predefined vocabulary. The server then supplies the token sequence, along with positional encodings, to the model for inference.
   In one embodiment, the generative AI model is pre-trained on a large corpus of text using an unsupervised language modeling objective and is then optionally fine-tuned on task-specific data containing pairs of input documents and desired hashtag-like identifiers. The server invokes the model via a model inference API. During inference, the server sets parameters such as temperature, top-k or top-p sampling thresholds, and a maximum number of output tokens to bias the model toward deterministic, concise outputs. The server thereby obtains model outputs that are short textual sequences containing candidate labels. Because the model internally uses attention mechanisms instead of simple keyword frequency counting, the model can identify contextually important phrases that are not necessarily frequent. This yields more meaningful identifiers and reduces the need for complex rule-based post-processing.
   The server may further refine the model output through additional logic. For example, the server may require that each output token sequence begins with a specified prefix (“#”), ends with a space or line break, and does not contain certain forbidden characters. To enforce these constraints, the server may use constrained decoding, where only tokens satisfying a predetermined pattern are allowed at certain positions. This type of decoding is technically distinct from human keyword selection and enables the server to maintain a consistent machine-readable identifier format without costly post-hoc corrections.
   After receiving the model output, the server parses the generated text into a set of individual identifiers. The server splits the text by line breaks or delimiters, removes leading and trailing whitespace, normalizes case, and converts internal spaces to underscores. The server then performs duplicate elimination by comparing identifiers in a normalized form and discarding entries that differ only by case or minor punctuation variations. The server optionally computes a frequency or confidence estimate for each identifier based on its position or the model's log probabilities and limits the number of identifiers per document according to a configurable threshold. By storing identifiers in an array or list structure associated with each information source, the server creates structured metadata that can be indexed and searched efficiently.
   The server generates structured data that associates, for each candidate information source, metadata such as a title, a summary snippet, a uniform resource locator, and the array of identifiers. The server may encode this structured data in a format such as a typed record or object. The server uses this structured representation to perform further ranking, filtering, or caching. For example, the server may maintain an in-memory index keyed by identifiers, where each key maps to a list of information source identifiers. This index allows the server to respond to subsequent narrowing operations from the terminal by retrieving only those information sources that share selected identifiers.
   The terminal receives the structured data from the server via the communication network and renders a user interface that presents search results. The terminal uses a rendering engine of a browser or a user interface framework of a native application to display each information source as a visual component including the title, a summary snippet, and a set of clickable labels corresponding to the identifiers. The terminal applies visual styling to the labels so that a user can easily distinguish them, for example by color, shape, or border. When the user selects one of the labels, the terminal transmits a refinement signal to the server identifying the selected identifier. The server then uses its internal index to rapidly compute a reduced set of search results matching that identifier, thereby reducing both computational load and network traffic in comparison to re-executing a full-text search.
   The invention achieves a technical improvement in computer technology by modifying the structure and flow of data within the information retrieval pipeline. Unlike conventional systems that simply present raw results or apply static keyword extraction, the server transforms unstructured document content into structured, model-guided identifiers through a sequence of machine-optimized operations: structured parsing, normalization, constrained prompt generation, transformer-based inference, and format-controlled decoding. This combination of operations yields identifiers that are well-suited to indexing, caching, and interactive filtering. As a result, the server reduces the number of documents that must be fully transmitted and rendered for each refinement step, lowers the average latency of interactive operations, and improves memory utilization by storing compact identifiers instead of large text segments.
   The server uses the generative AI model in a way that is not a mere automation of human mental processes. The server relies on specific internal model structures, such as multi-head self-attention layers, layer normalization, and residual connections, to compute vector representations that capture long-range dependencies in documents. The server selects hyperparameters such as the number of layers, the dimensionality of the hidden state, and the number of attention heads so that the model can handle long web documents while respecting computational constraints. The server also employs a particular training regime in which the model is optimized using gradient-based learning, a loss function such as cross-entropy over predicted tokens, and regularization techniques such as dropout. Training data may be augmented by automatically generated examples that include synthetic documents and desired identifier sets generated by rules, enabling the model to generalize to unseen inputs. These techniques collectively produce a model that can output stable, label-like identifiers under the control of the prompt sentence, a behavior that is not obtainable by simple rule-based systems.
   The technical effects of the described configuration are multifold. By forcing the generative AI model to output constrained identifiers, the server reduces the size and complexity of data that need to be transferred to the terminal and processed in subsequent requests, thereby decreasing communication load and improving throughput. By associating identifiers with information sources in a structured index, the server performs narrowing operations using fast index lookups instead of expensive full-text searches, thereby improving processing speed and reducing computational cost. By applying normalization and length control to the input text, the server stabilizes model behavior, leading to more consistent identifiers and reducing the need for repeated model invocations. These improvements are directly tied to the specific technical configuration and processing steps of the server and do not simply reflect generic business logic or high-level human decision-making.
   In alternative embodiments, the server may employ different model architectures while preserving the core concept of structured prompt control and identifier generation. For example, the server may use an encoder-only transformer to compute contextual representations for the preprocessed text and then apply a classification head that assigns each candidate term a relevance score. The server may construct a candidate term list using a statistical term extraction algorithm (such as part-of-speech tagging and noun phrase chunking) and then apply the model's scores to select the top-ranked terms as identifiers. In another embodiment, the server may use a sequence-to-sequence transformer, where an encoder processes the preprocessed text and a decoder generates identifiers under a constrained output vocabulary. Regardless of the specific architecture, the server maintains the structure of generating a prompt sentence, encoding instructions into the model input, and producing identifiers in a controlled format.
   The server can also support multiple display and interaction strategies at the terminal. In one embodiment, the terminal groups identifiers into categories, such as technical features, performance aspects, and usage scenarios, based on additional tags computed by the server.
   In another embodiment, the terminal caches previously received identifiers and employs client-side filtering to avoid repeated communication with the server when the user repeatedly toggles the same labels. In each case, the identifiers generated by the server's specialized processing enable richer, more responsive user interfaces without increasing the computational burden on the terminal.
   By tightly coupling the design of the prompt sentence, the preprocessing pipeline, the generative AI model configuration, the post-processing algorithms, and the data structures used in indexing and rendering, the invention provides a concrete improvement in the functioning of the computer system as a whole. The server transforms raw, heterogeneous document data into compact, structured metadata in the form of identifiers that are directly usable for high-speed indexing and interactive filtering, thereby achieving measurable improvements in response time, relevancy, and resource utilization compared to conventional systems that do not employ such coordinated processing.

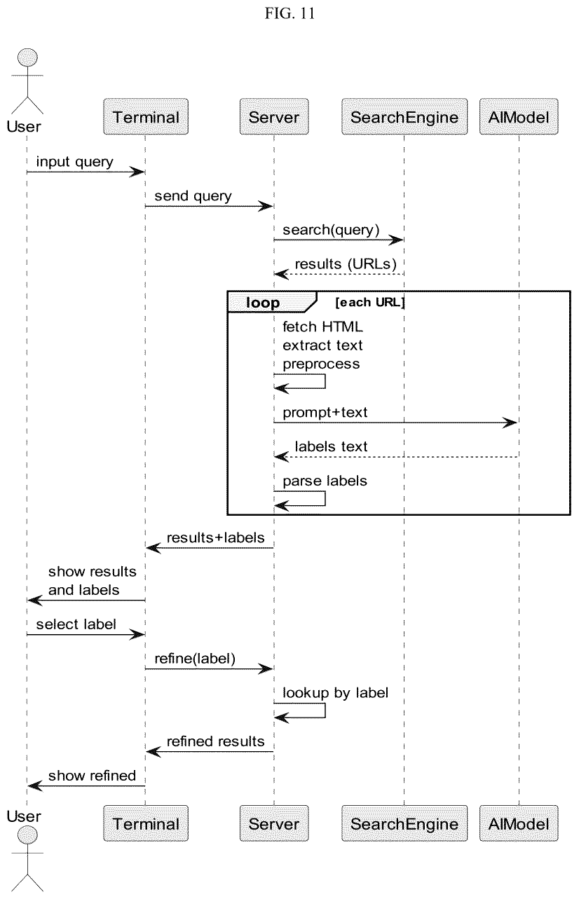

The following describes the processing flow using FIG. 11.

### Step 1:

User operates the terminal and inputs a search query.
User types a text string, such as “latest smartphone with good camera,” into a search field displayed on the terminal.
Input: Raw keystrokes and characters entered by the user.
Output: A finalized query string stored in the terminal's memory, for example “latest smartphone with good camera”.
Terminal packages this query string into a request object in an internal data structure and prepares it for transmission to the server.

### Step 2:

Terminal transmits the search request to the server.
Terminal embeds the query string into an HTTP request payload, for example a JSON object including a “query” field, and sends it via a communication interface over a network.
Input: The query string and endpoint information for the server.
Output: An HTTP request containing the query string, delivered to the server's network interface.
Terminal uses a transport protocol stack to encapsulate the request, and the server receives the request at a listening port.

### Step 3:

Server receives and validates the search request.
Server parses the HTTP request, extracts the JSON payload, and reads the “query” field as a UTF-8 string.
Input: The HTTP request including the query string.
Output: A validated internal query object containing the normalized query text.
Server trims whitespace, checks for invalid characters, applies a maximum length constraint, and discards or rejects malformed requests. The server logs the validated query with a timestamp for monitoring.

### Step 4:

Server obtains candidate information sources from an external information retrieval mechanism.
Server constructs a request to an external search engine API, embedding the query text into the required parameter format.
Input: The internal query object containing the user's query string.
Output: A list of candidate information sources represented as structured records including at least a URL, title, and snippet for each source.
Server sends the query to the external mechanism, receives a response (e.g., in JSON format), and converts the response into internal data structures, discarding entries that do not meet basic criteria such as supported document type.

### Step 5:

Server retrieves document data for each candidate information source.
Server iterates over the list of URLs in the candidate list and issues HTTP GET requests to each URL.
Input: The list of candidate information source records containing URLs.
Output: A mapping from each URL to its corresponding raw document data, such as an HTML string.
Server applies connection timeouts and retry policies, and for each successful response, stores the raw document content in memory or a cache for further processing.

### Step 6:

Server parses document data to extract main text information.
Server uses a document parser to build a document object model from each HTML document and traverses the node tree to separate main content from auxiliary elements.
Input: The raw HTML document data for each information source.
Output: Main text information for each information source, represented as a plain text string.
Server removes nodes corresponding to navigation menus, style definitions, and scripts by filtering on tag types and attributes, then concatenates text from content-rich elements, normalizes whitespace, and stores the resulting main text with a reference to the source.

### Step 7:

Server preprocesses the main text information.
Server performs character normalization (e.g., unifying quotation marks, standardizing punctuation, and removing control characters) and enforces a length limit by truncating text that exceeds a predefined size.
Input: Main text information per information source.
Output: Preprocessed text strings that are normalized and length-limited for each information source.
Server may compute an approximate token count to align with the generative AI model's token capacity, discarding trailing segments when necessary, and records preprocessing metadata such as original length and truncated length.

### Step 8:

Server constructs a prompt sentence for the generative AI model.
Server combines a predefined instruction template in natural language with the preprocessed text to form a full prompt sentence.
Input: The preprocessed text strings and a stored prompt template.
Output: A prompt sentence for each information source, ready for input to the generative AI model.
Server, for example, generates a prompt of the form:
“From the following web page text, extract 5-10 important keywords that represent the main topics, and output them only as identifiers in hashtag format (e.g., #keyword). Use concise English terms, no explanations. Text: [TEXT]”
   Server replaces [TEXT] with the preprocessed text, ensuring that the combined length remains within the model's token limit.

### Step 9:

Server submits the prompt sentence and text to the generative AI model and performs inference.
Server tokenizes the prompt sentence, encodes the tokens, and forwards them to a transformer-based generative AI model via an inference interface.
Input: The prompt sentence and associated preprocessed text for each information source.
Output: Generated text containing candidate identifiers or label-like phrases for each information source.
Server sets inference parameters such as temperature, maximum output tokens, and sampling strategy to bias the model toward short, deterministic outputs. The model computes internal attention-based representations and returns a sequence of tokens, which the server decodes into a text string.

### Step 10:

Server postprocesses the generative AI model output to obtain identifiers.
Server splits the generated text into separate items (for example, by line breaks or spaces) and normalizes each item to form a clean identifier.
Input: The raw text output produced by the generative AI model.
Output: A list or array of normalized identifiers (such as hashtags) per information source.
Server trims whitespace, ensures that each identifier begins with a prefix (for example, “#”), replaces spaces with underscores, converts text to a standardized case, and removes invalid characters. The server detects and removes duplicate identifiers and limits the number of identifiers according to a configured maximum.

### Step 11:

Server associates identifiers with information sources and builds structured search result data.
Server attaches the list of identifiers to the corresponding record for each information source, alongside title, snippet, and URL.
Input: The list of identifiers for each information source and the original candidate information source records.
Output: Structured search result data in which each information source is represented by a record containing metadata and identifiers.
Server encodes these records into a structured format suitable for transmission, such as an array of objects, and may add additional fields indicating processing status or ranking scores.

### Step 12:

Server transmits the structured search result data and display control information to the terminal.
Server prepares a response message containing the result records and additional information specifying how titles, snippets, and identifiers should be displayed or interacted with by the terminal.
Input: The structured search result data and any display control metadata.
Output: A response message, such as an HTTP response containing the structured data and control information, sent to the terminal.
Server sets content-type headers, serializes the internal data structure into a transmission format, and sends the response via the network interface.

### Step 13:

Terminal receives the structured search results and updates the local data model.
Terminal reads the incoming response, parses the structured data, and stores the result records in the client-side memory or state management structure.
Input: The response message containing structured search results and display control information.
Output: An updated internal representation of search results ready for rendering on the display.
Terminal checks for data integrity, handles any error codes, and prepares visual components based on the received control information.

### Step 14:

Terminal renders search results including identifiers on the display.
Terminal creates user interface elements for each information source, such as a card showing a title, a snippet, and interactive labels corresponding to the identifiers.
Input: The internal representation of search results and associated display control information.
Output: A rendered screen in which titles, snippets, and identifiers are visible and selectable by the user.
Terminal applies styling rules to identifiers (for example, color and shape), arranges result cards, and attaches event handlers to detect selection operations on identifiers.

### Step 15:

User inspects the rendered identifiers and performs a selection operation.
User visually scans the identifiers displayed under each result and taps or clicks an identifier that corresponds to an aspect of interest, for example “#camera_performance”.
Input: The displayed search result interface with interactive identifiers.
Output: A user interaction event indicating which identifier has been selected.
Terminal captures the event and generates a refinement request or a navigation request based on the selected identifier.

### Step 16:

Terminal sends a refinement or navigation request to the server based on the selected identifier.
Terminal packages the selected identifier, and optionally the original query, into a new request and transmits it to the server.
Input: The user interaction event containing the selected identifier.
Output: A refinement or navigation request message delivered to the server that specifies the identifier as a filter or navigation target.
Terminal may also update its display to indicate that a filtering operation is in progress while awaiting the server's response.

### Step 17:

Server processes the refinement or navigation request using identifiers.
Server reads the selected identifier from the request and uses an internal index or mapping from identifiers to information sources to determine relevant results.
Input: The refinement or navigation request containing the selected identifier.
Output: A filtered or targeted set of search result records that match the selected identifier, encoded as structured data.
Server avoids re-issuing the full external search and instead performs a lookup in its identifier-based index to quickly produce the narrowed set, thereby reducing computational and communication overhead.

### Step 18:

Server transmits the refined search results to the terminal, and terminal updates the display.
Server sends the filtered result set as a response to the terminal, and the terminal replaces or augments the previously displayed results with the refined set.
Input: The filtered search result records produced by the server.
Output: An updated user interface on the terminal showing a narrowed list of information sources corresponding to the selected identifier.
Terminal re-renders the list, again including identifiers for each item, allowing the user to further refine or navigate, while the server continues to manage identifier-based filtering and data retrieval in subsequent interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.
Conventional search and recommendation systems in electronic information environments rely primarily on keyword matching and manually curated tags to present search results to users. In many implementations, a server retrieves item descriptions and user reviews from a data store and returns raw or minimally processed text to a client device. As a result, a user must open and read multiple detailed pages in order to understand the essential features of items or other information sources. This leads to increased network usage, higher processing load on both client and server, and degraded usability due to redundant rendering of large text payloads.
Furthermore, existing systems that attempt to summarize or tag content often employ static rule-based pipelines, fixed vocabularies, or simplistic statistical ranking, which are not optimized to dynamically adapt to heterogeneous domains or rapidly changing content. These approaches tend to generate generic or noisy tags that do not accurately reflect the distinguishing characteristics of each item. In addition, many systems that use machine learning models do not tightly integrate prompt construction or identifier normalization with upstream natural language processing, resulting in suboptimal utilization of model capabilities and inefficient computation.
When generative AI models are used in existing solutions, they are frequently invoked with ad hoc or non-structured prompts, without systematic extraction and selection of high-value phrases from underlying item descriptions and evaluations. This can cause the generative AI models to produce verbose, inconsistent, or irrelevant outputs, increasing processing time, consuming more computational resources, and requiring complex post-processing.
Consequently, server resources such as processor cycles, memory bandwidth, and network throughput are not efficiently used, and the responsiveness and scalability of the system are impaired, particularly under high query volumes.
There is therefore a need for a computer-implemented technique that improves the way in which server-side components process description information and evaluation information, construct prompt sentences for generative AI models, and transform the outputs of such models into concise, normalized identifiers that can be directly associated with search results. Such a technique should reduce unnecessary data transfer and redundant server processing, while producing high-quality identifiers that allow a user to understand item features at a glance, thereby improving overall computer system efficiency and user experience in search and recommendation workflows.

The specific processing by the specific processing unit 290 of the data processing device 12 in Application Example 1 is realized by the following means.

The present invention provides a server comprising a processor configured to receive a search request from a user via a terminal, to collect, on the basis of the search request, information sources including description information and evaluation information relating to an item from an information storage medium, to execute a natural language processing program to perform morphological analysis, normalization of word forms, removal of non-informative terms, and calculation of occurrence frequency and importance so as to extract phrases representing features from the description information and the evaluation information, to generate a structured prompt sentence including at least one of the extracted phrases or a part of the description information and the evaluation information and including an instruction that a generative AI model generate only a predetermined number of short identifiers in a predetermined language, to transmit the prompt sentence to the generative AI model and obtain identifier candidates generated by the generative AI model in response to the prompt sentence, to normalize the identifier candidates into a predetermined format to determine identifiers representing features of the item, and to associate the determined identifiers with item information corresponding to the search request and transmit the item information and the determined identifiers to the terminal so as to cause the terminal to display the item information together with the determined identifiers. This enables improved utilization of computational resources in the server by constraining generative model processing with feature-focused prompt sentences, reduces unnecessary transfer and rendering of verbose textual content between the server and the terminal, and provides concise, machine-generated identifiers that allow a user to efficiently grasp distinguishing item features, thereby enhancing the technical performance, scalability, and responsiveness of the computer-implemented search and recommendation system.

The term “system” refers to a combination of hardware components and software components configured to execute one or more information processing functions in a coordinated manner.

The term “processor” refers to a hardware computation unit, such as a central processing unit or a graphics processing unit, configured to execute instructions of one or more programs to perform operations on data.
The term “user” refers to a human operator who interacts with the system through an input/output interface of a terminal.
The term “terminal” refers to an information processing device, such as a client computing device, configured to transmit a request to the server and to receive and display information returned from the server.
The term “search request” refers to a data structure including at least one query element, such as a keyword or parameter, that is transmitted from the terminal to the server to request retrieval of related information sources.
The term “information storage medium” refers to a physical or virtual storage resource, such as a database system or file system, configured to store information sources including item-related data.
The term “information source” refers to a collection of data records stored in the information storage medium, the data records including at least description information and evaluation information relating to an item.
The term “item” refers to an object, good, service, or content entity for which description information and evaluation information are stored and retrieved in response to a search request.
The term “description information” refers to structured or unstructured data expressing attributes, specifications, or characteristics of an item in a natural language text form or similar form.
The term “evaluation information” refers to data representing assessments, opinions, or feedback about an item, including, for example, user reviews or ratings expressed in natural language text or equivalent representation.
The term “character information” refers to textual data composed of characters or symbols that can be processed by natural language processing techniques.
The term “natural language processing program” refers to a software component configured to analyze and transform character information according to natural language processing techniques, including at least tokenization, morphological analysis, normalization of word forms, and removal of non-informative terms.
The term “morphological analysis” refers to processing of character information to segment text into tokens and to determine linguistic attributes of the tokens, such as parts of speech or base forms.
The term “normalization of word forms” refers to processing for converting inflected or variant word forms into canonical forms, such as base forms, stems, or lemmas, to reduce variation in textual data.
The term “non-informative term” refers to a token, such as a functional word or high-frequency generic word, that has low contribution to representing distinguishing features of an item and is therefore removed during natural language processing.
The term “occurrence frequency” refers to a quantitative measure of how often a phrase or term appears within description information or evaluation information.
The term “importance” refers to a numerical or categorical measure indicating the relevance or distinctiveness of a phrase or term with respect to describing features of an item, computed using a statistical method or a machine learning method.
The term “phrase representing features” refers to a word or a combination of words extracted from description information or evaluation information that characterizes a property or attribute of an item.
The term “prompt sentence” refers to a natural language instruction string constructed by the processor and supplied as input to a generative AI model in order to control or condition the generation of output identifiers.
The term “generative AI model” refers to a machine-learning-based model configured to generate text data in response to input data, the model being trained on sample text data and capable of producing identifiers according to a prompt sentence.
The term “identifier candidate” refers to a unit of text generated by the generative AI model in response to a prompt sentence before normalization, the unit of text being suitable for conversion into an identifier.
The term “identifier” refers to a normalized, concise textual label, such as a tag or keyword, that represents a feature of an item and is associated with the item for display to the user.
The term “predetermined format” refers to a specified structural rule or representation pattern, such as a particular character set, prefix, length, or delimiter convention, used to normalize identifier candidates into identifiers.
The term “predetermined number” refers to a specific quantity or upper limit of identifiers to be generated by the generative AI model, the quantity being defined in advance by system configuration or control parameters.
The term “predetermined language” refers to a specific natural language, such as a target display language for the user interface, designated in advance for output of identifiers from the generative AI model.
The term “item information” refers to a set of data elements associated with an item, including at least an identifier of the item and description information, and optionally further including price information, category information, or media information.
The term “associate” refers to establishing and storing a logical relationship between identifiers and item information such that the identifiers can be retrieved and displayed together with the corresponding item information.

In one embodiment, a server cooperates with a terminal used by a user to implement the claimed system. The server includes at least one processor, a main memory, a non-volatile storage device, and a network interface. The terminal includes at least one processor, a memory, a display, and an input device such as a keyboard or touch panel. The server and the terminal communicate over a communication network using a transport protocol and an application-level protocol.

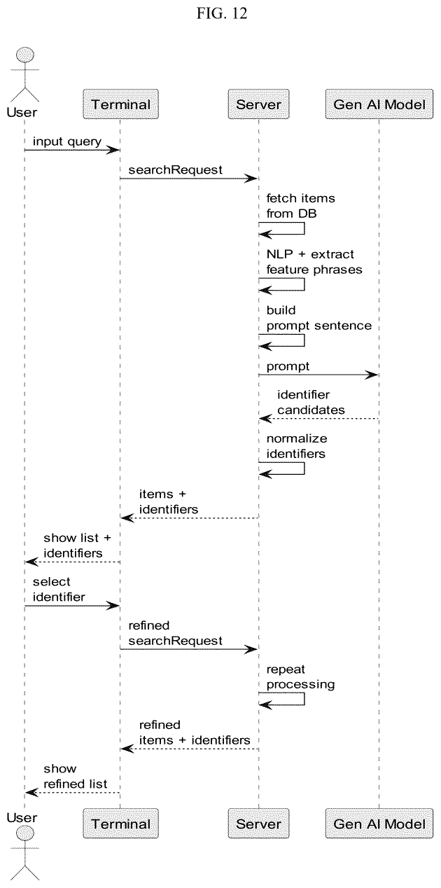

The server executes an operating system and one or more application programs implementing a search service. The server also executes a natural language processing program and a generative AI model execution program. The server stores information sources, including description information and evaluation information relating to items, in a data store such as a relational database or a document store. The data store is implemented, for example, by a relational database management system or a key-value database.
The server uses a natural language processing library, for example a library implementing tokenization, part-of-speech tagging, lemmatization, and stop-word filtering, such as a general-purpose natural language processing toolkit. The server also uses a machine learning library, for example a library implementing term-frequency/inverse-document-frequency (TF-IDF) computation, vector representation of words, and clustering or ranking algorithms.
The server further uses a transformer-based neural network framework to execute a generative AI model such as an encoder-decoder transformer or a decoder-only transformer trained for text generation.
The server stores, in the data store, for each item, an item identifier, description information, and evaluation information. Description information is stored as one or more text fields, and evaluation information is stored as one or more text fields containing user comments or ratings. The server indexes these fields to support efficient retrieval in response to search requests.
The terminal presents to the user a graphical user interface implemented by a web browser or a native application. The terminal displays a search input field and receives a search query from the user. The terminal transmits the search request, including the search query and optional parameters such as language or category, to the server via the network interface.
The server receives the search request and accesses the data store to collect relevant information sources. The server retrieves item records whose description information or evaluation information matches the query according to a search algorithm such as inverted-index retrieval or full-text search. The server then passes the retrieved textual data to the natural language processing program.
The server performs, by the natural language processing program, a sequence of concrete data processing operations on the character information in the description information and evaluation information. The server segments the text into tokens by applying a tokenizer that scans character sequences and identifies word boundaries. The server applies morphological analysis by assigning part-of-speech tags to each token and converting each token to a normalized word form such as a lemma or base form. The server removes non-informative terms by comparing each token to a stop-word list and by applying thresholding rules based on token length or character type.
The server computes, by using a statistical method implemented in the machine learning library, an occurrence frequency for each token or phrase in the collected text. The server also computes an importance value for each token or phrase, for example by calculating TF-IDF scores, normalized mutual information, or other weighting schemes that consider both local frequency in the current item texts and global frequency in a background corpus stored in the data store. The server then selects phrases representing features by applying a ranking algorithm that orders tokens or phrases by their importance value and by their part-of-speech type. The server can retain primarily nouns and adjectives, and can group tokens into multi-word expressions based on n-gram co-occurrence statistics.
The server represents each selected phrase as a feature vector in a continuous vector space by using an embedding model such as a transformer-based encoder. The server can compute cosine similarity between vectors to detect redundant or near-duplicate phrases. The server merges similar phrases according to a similarity threshold, thereby generating a compact set of phrases representing features for each item. This step reduces computational load in subsequent processing and improves precision of generated identifiers.
The server constructs, from the compact set of phrases and optionally from representative snippets of description information and evaluation information, a prompt sentence for a generative AI model. The server arranges the phrases in a predetermined template and inserts control instructions specifying a target language, a maximum number of identifiers, and a desired output format. For example, the server may construct a prompt sentence such as: “Here are main feature phrases for smartphone cases: shockproof, lightweight, stylish, durable. Generate 5 short Japanese hashtags that best represent these features. Output only hashtags, separated by commas.”
In another example, the server may construct a prompt sentence such as:
“Analyze the following product descriptions and customer reviews for smartphone cases and generate concise hashtags that represent the main features (durability, weight, design, usability). Return 5-10 hashtags, in Japanese, without explanations.”
   The server transmits the prompt sentence, as a sequence of tokens, to the generative AI model. In one embodiment, the generative AI model is implemented as a transformer-based neural network deployed on a graphics processing unit. The generative AI model comprises multiple layers of self-attention and feedforward sublayers. Each attention layer calculates attention weights by applying a scaled dot-product operation to query, key, and value vectors derived from the input token embeddings. Each feedforward sublayer applies linear transformations and non-linear activation functions to intermediate representations. The model parameters, including weight matrices and bias vectors, are stored in the memory of the server and are accessed by the processor during inference.
   The server trains the generative AI model in advance on a training dataset of text sequences that include pairs of feature phrases and corresponding identifiers. During training, the server minimizes an error function such as cross-entropy loss between the predicted token sequence and a ground-truth identifier sequence. The server updates the model weights by using an optimization algorithm such as stochastic gradient descent with adaptive learning rate, and optionally uses regularization techniques and data augmentation such as synonym substitution or random masking of tokens. As a result, the generative AI model learns to map input prompt sentences containing feature phrases to output sequences that consist of concise identifiers with desired characteristics.
   During operation, the server executes the trained generative AI model in inference mode. The server encodes the prompt sentence into token embeddings by applying an embedding layer, propagates the embeddings through the transformer layers, and decodes the output tokens by using a probability distribution over the vocabulary produced by a softmax function in the output layer. The server applies a decoding strategy such as top-k sampling, nucleus sampling, or beam search, with parameters chosen to favor short, distinct, and high-probability candidate identifiers. The server thus obtains identifier candidates as machine-generated text segments.
   The server normalizes the identifier candidates by applying text processing rules. The server removes leading and trailing whitespace, converts the text to a uniform case if appropriate for the language, and ensures that each identifier candidate conforms to a predetermined format, for example including a leading hash symbol and excluding invalid characters. The server filters out identifier candidates that are duplicates or that do not meet length constraints. The server then determines a final set of identifiers representing features for each item.
   The server associates the determined identifiers with corresponding item information by storing the identifiers in an index structure or a relational table that links item identifiers to identifier strings. The server returns, to the terminal, a response that includes for each item at least the item identifier, primary display attributes such as a title or a price, and the determined identifiers. The terminal receives the response, decodes it, and updates the graphical user interface.
   The terminal displays, for each item in a search result list, the determined identifiers in association with the item. The terminal can display the identifiers, for example, as hashtag-like labels beneath an item title. The user views these identifiers and can understand main features of the item without opening a detailed page. The user may select one of the identifiers, and the terminal transmits a refined search request including the selected identifier as a filter to the server, enabling further narrowing of results.
   The server, by constructing the prompt sentence from phrases representing features that have been extracted and ranked in advance, reduces the input length and semantic ambiguity presented to the generative AI model. This leads to more precise and consistent identifiers, reduces the number of model inference steps, and decreases processor and memory usage on the server. The server also reduces the amount of description information and evaluation information that must be transmitted to the terminal, because the terminal can operate primarily on concise identifiers rather than on full-length text. Consequently, network bandwidth consumption decreases, and rendering load on the terminal is reduced.
   The server improves the functioning of the underlying computer system in several ways. First, by using importance-based phrase selection and vector-space redundancy reduction prior to generative inference, the server shortens and structures input data, which accelerates neural network computation and lowers energy consumption on the processing hardware. Second, by constraining the generative AI model through explicit instructions in the prompt sentence regarding language, number of identifiers, and format, the server reduces variability of outputs and simplifies post-processing. Third, by normalizing identifier candidates into a predetermined format and storing them in a specific data structure optimized for retrieval, the server improves caching efficiency and search latency for subsequent requests that reuse previously generated identifiers.
   The server processes information in a manner that is not a mere automation of human reading or tagging. The server applies a sequence of machine-executable steps, including numerical feature computation, vector similarity comparison, and neural inference, which depend on structured internal representations and weight matrices not interpretable by a human reader. The server employs a non-conventional pipeline that integrates deterministic natural language processing, statistical ranking, embedding-based redundancy reduction, structured prompt construction, and transformer-based text generation, producing technical effects such as higher throughput per processor core and reduced error rates in feature summarization compared to rule-based or purely manual approaches.
   In another embodiment, the server employs an alternative natural language processing program that uses a recurrent neural network or a convolutional neural network to compute importance scores, instead of or in addition to TF-IDF. In still another embodiment, the server uses a different generative AI model architecture, such as a sequence-to-sequence encoder-decoder with attention, trained with a similar loss function and optimization procedure. In yet another embodiment, the server adjusts decoding parameters dynamically depending on the length of the prompt sentence or the number of phrases representing features, thereby further optimizing inference time and identifier diversity.
   In a further embodiment, the terminal performs part of the processing associated with rendering and interaction with identifiers. The terminal may locally store previously received identifiers and use them to pre-populate suggestions while the user enters a search query, reducing round-trip latency for common queries. The terminal may also cache images and layout metadata so that the server can send only updated identifiers, further reducing communication overhead.
   The server enables the technical effects described above through specific data structures and processing flows. The server maintains, in memory, a phrase table storing, for each item, a vector of phrases representing features, associated importance scores, and identifier strings.
   The server maintains an embedding matrix used to compute vector representations of phrases.
   The server uses an index structure to enable fast lookup of identifiers by item identifier and by identifier text. These structures allow the server to update and retrieve identifiers efficiently, to support high request throughput, and to maintain low response times.
   Through these concrete arrangements of hardware, software, data structures, and algorithmic processing, the server and the terminal implement the claimed system in a way that improves computer operation itself, including processing speed, resource utilization, and communication efficiency, while providing the user with concise, machine-generated identifiers that accurately represent item features.
   The following describes the processing flow using FIG. 12.

### Step 1:

The user operates the terminal to enter a search query and optional filter parameters into a search input field displayed on a graphical user interface. The terminal receives, as input, user keystrokes or touch events and constructs a search request data structure including at least a query string and metadata such as language and category. The terminal outputs a formatted request message, for example an HTTP request containing the search request data, and transmits this message to the server via a network interface.

### Step 2:

The server receives the request message from the terminal through a network interface and parses protocol headers and a payload body. The server takes, as input, the raw request bytes and decodes them into an internal representation such as a structured object containing the query string and parameters. The server outputs a validated search request object after performing syntax checks, character encoding normalization, and logging of request metadata.

### Step 3:

The server accesses a data store to retrieve item records whose stored description information and evaluation information are relevant to the search request. The server receives, as input, the search request object and uses the query string to formulate one or more database queries, for example full-text search or inverted-index lookups. The server executes the queries, obtains as output a set of item records including item identifiers, description texts, and evaluation texts, and loads these records into memory as structured data.

### Step 4:

The server aggregates textual fields for each item to prepare input text for natural language processing. The server receives, as input, the set of item records from the data store and, for each item, concatenates or groups description information and evaluation information into one or more text documents. The server outputs, for each item, at least one character string representing combined textual content, and stores these strings in a data structure such as a list or array keyed by item identifier.

### Step 5:

The server performs tokenization and morphological analysis on the aggregated text for each item by using a natural language processing program. The server takes, as input, a character string for a given item and applies tokenization rules to split the string into tokens corresponding to words, symbols, or subwords. The server then applies morphological analysis to assign part-of-speech tags and base forms to each token. The server outputs a token sequence with associated linguistic attributes, such as lemma, part of speech, and position indices, and stores this sequence in memory for further processing.

### Step 6:

The server removes non-informative terms and normalizes word forms to reduce noise in the textual data. The server receives, as input, the token sequence with linguistic attributes and compares each token against a stop-word list and simple heuristic rules (for example minimum length, presence of only digits, or belonging to a predefined ignore list). The server discards tokens identified as non-informative and converts remaining tokens to normalized forms such as lemmas or lowercased variants. The server outputs a filtered and normalized token list for each item.

### Step 7:

The server computes occurrence frequency and importance scores for tokens and phrases within the filtered text. The server takes, as input, the normalized token list and constructs term frequency vectors representing how often each token appears in the item's description information and evaluation information. The server also accesses global statistics stored in the data store to compute inverse document frequency or other global measures. The server applies a statistical algorithm, such as TF-IDF, to generate, as output, an importance score for each token. The server stores these scores alongside token identifiers in a feature table.

### Step 8:

The server selects candidate phrases representing features based on importance scores and part-of-speech patterns. The server receives, as input, tokens with importance scores and linguistic attributes and applies selection rules that prioritize tokens tagged as nouns or adjectives, optionally forming multi-word phrases from adjacent tokens that frequently co-occur. The server sorts tokens or phrases by importance and selects top-ranked entries within predefined thresholds. The server outputs a ranked list of candidate phrases for each item.

### Step 9:

The server reduces redundancy among candidate phrases by using vector representations and similarity calculations. The server takes, as input, the ranked list of candidate phrases and, for each phrase, generates a vector embedding using a phrase encoder such as a transformer-based encoder. The server calculates pairwise cosine similarity scores between phrase vectors and groups highly similar phrases into clusters according to a similarity threshold. The server selects representative phrases from each cluster and suppresses near-duplicate phrases. The server outputs a compact list of non-redundant phrases representing features for each item.

### Step 10:

The server constructs a prompt sentence for a generative AI model by embedding the compact list of phrases into a controlled natural language template. The server receives, as input, the compact list of phrases and optional snippet text from the original description information or evaluation information. The server inserts the phrases and snippets into a template that specifies constraints such as output language, number of identifiers, and desired format. The server outputs a prompt sentence string, such as “Here are main feature phrases for smartphone cases: shockproof, lightweight, stylish, durable. Generate 5 short Japanese hashtags that best represent these features. Output only hashtags, separated by commas.”

### Step 11:

The server transmits the prompt sentence to a generative AI model and initiates inference. The server takes, as input, the prompt sentence string and converts it into token IDs using a tokenizer associated with the generative AI model. The server passes the token IDs to the model execution engine running on a processor or a graphics processing unit. The server outputs model input tensors representing token embeddings and configuration parameters such as maximum output length and sampling strategy.

### Step 12:

The server executes the generative AI model to produce identifier candidates based on the prompt sentence. The server receives, as input, the model input tensors and processes them through multiple neural network layers including self-attention and feedforward sublayers. The server computes attention weights, intermediate activations, and output token probability distributions for each decoding step, using matrix multiplications and non-linear activation functions. The server applies a decoding algorithm such as beam search or top-k sampling to select token sequences that maximize likelihood under specified constraints. The server outputs one or more text sequences that serve as identifier candidates.

### Step 13:

The server parses and normalizes the identifier candidates into a predetermined format suitable for display and indexing. The server takes, as input, the raw text sequences generated by the generative AI model and splits each sequence according to delimiters such as commas, spaces, or line breaks. The server trims whitespace, removes invalid characters, enforces maximum and minimum length constraints, and ensures that each identifier begins with a selected prefix, for example a hash symbol. The server removes duplicate identifiers and optionally ranks them by confidence or relevance if such information is available. The server outputs a finalized list of normalized identifiers for each item.

### Step 14:

The server associates the finalized identifiers with corresponding item information and prepares a response structure for the terminal. The server receives, as input, the list of normalized identifiers and the original item records retrieved earlier. The server creates or updates a mapping data structure that links item identifiers to identifier strings, and then constructs a response object containing, for each item, at least the item identifier, key display attributes, and the list of identifiers. The server outputs a serialized response, for example encoded as a structured message, and transmits it to the terminal via the network interface.

### Step 15:

The terminal receives the response from the server and updates the graphical user interface to present the identifiers to the user. The terminal takes, as input, the serialized response and decodes it into internal data objects representing items and associated identifiers. The terminal generates or updates visual elements such as item tiles, lists, or cards and attaches interactive labels for each identifier, formatted as distinct graphical components. The terminal outputs rendered display content to the screen, showing the item information together with the generated identifiers.

### Step 16:

The user views the displayed identifiers and may refine the search by selecting one or more identifiers. The user receives, as input, the visual presentation of items and identifiers on the terminal display and performs selection operations using a pointing device or touch interface. The user outputs a refinement intention in the form of a selection action on a displayed identifier.

### Step 17:

The terminal captures the user's selection of an identifier and generates a refined search request including the selected identifier as a filter condition. The terminal receives, as input, the user interaction event associated with a particular identifier and constructs a new search request object that includes both the original query and the chosen identifier as an additional constraint. The terminal outputs a new request message containing this refined search request and transmits it to the server, enabling the server to repeat the processing with updated conditions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.
Conventional information retrieval systems, including electronic commerce platforms and general search services, typically rely on fixed keyword matching, manually curated category trees, or pre-defined metadata schemas. In such systems, a processor generally executes straightforward matching or filtering logic over a static index or database. These approaches suffer from several technical limitations when operating on large-scale, heterogeneous data that includes both structured information (for example, product records) and unstructured information (for example, free-text descriptions or images).
First, existing systems are technically constrained in their ability to automatically derive high-quality, fine-grained identifiers that accurately reflect salient features of each information item. When unstructured text or image data is stored in an information storage device, conventional search engines index raw terms or low-level features but do not dynamically generate abstracted identifiers that are consistent across items. As a result, a processor in such systems cannot efficiently construct a compact, discriminative representation of each information item, which leads to suboptimal query processing, coarse filtering, and degraded ranking quality, particularly under ambiguous or broad search conditions.
Second, prior systems do not effectively leverage advanced machine learning models, such as generative AI models, as an integrated part of the search pipeline. Even when such models are employed, they are often invoked in an ad-hoc manner, without a systematic mechanism for constructing prompt sentences, normalizing model outputs, and storing generated identifiers in association with information items within the information storage device.
Consequently, the processor cannot reliably exploit the semantic capabilities of generative AI models for large-scale, repeatable, and low-latency retrieval operations.
Third, known systems provide limited support for interactive refinement of search results based on identifiers that are automatically generated from underlying data. User interfaces frequently present static filters defined by system designers, rather than dynamically generated identifiers that are derived from current data and user context. Therefore, the processor is not configured to receive refinement requests based on adaptable identifiers generated at query time, and cannot efficiently re-query the information storage device using such identifiers as search keys. This results in increased computational overhead, redundant data transfers, and longer response times, thereby reducing the overall efficiency of the computing system.
Fourth, there is insufficient technical integration between the generation of identifiers by a generative AI model and downstream search operations. In many implementations, the model output is used only for display or summarization, and is not persisted or indexed in a form suitable for subsequent machine-driven filtering. This leads to wasted compute resources, because the same or similar analysis must be recomputed for subsequent queries, and prevents the processor from building an optimized index over the generated identifiers for fast retrieval.
Accordingly, there is a need for an improved computer-implemented system in which a processor cooperates with a generative AI model, via explicitly constructed prompt sentences, to preprocess information stored in an information storage device, generate normalized identifiers representing features of information items, store those identifiers in association with the items, and use the stored identifiers as machine-actionable search conditions for interactive refinement. Such a system should enhance the technical performance of the information retrieval pipeline, including improved relevance of results, reduced query latency, and more efficient utilization of computing and storage resources.
The specific processing by the specific processing unit 290 of the data processing device 12 in Example 2 is realized by the following means.

The present invention provides a server comprising a processor and a communication interface, the processor being configured to receive, from a user terminal via the communication interface, a search request including a search condition, to acquire, from an information storage device, structured information and unstructured information based on the search condition, to perform preprocessing on the acquired information to generate input data to be provided to a generative AI model, to generate a prompt sentence including an instruction for processing by the generative AI model and the input data, to transmit a request including the prompt sentence to the generative AI model via the communication interface, to receive, from the generative AI model, natural language text output as an analysis result of the input data, to extract important expressions from the natural language text, to normalize the important expressions as a group of identifiers representing features of corresponding information items, to store the group of identifiers in association with the information items in the information storage device, to aggregate the group of identifiers per information item, to transmit the aggregated group of identifiers to the user terminal such that the identifiers are visually presented as selectable display elements, and to receive, from the user terminal, a refinement request including at least one identifier selected by a user from the selectable display elements, execute a search process on the information storage device based on the selected at least one identifier to extract information items associated with the selected at least one identifier, and transmit a search result to the user terminal. This enables the computing system to automatically transform heterogeneous information into machine-actionable identifiers using a generative AI model under control of explicitly constructed prompt sentences, to persist and index the identifiers within the information storage device, and to perform low-latency, high-relevance retrieval and interactive refinement based on the identifiers, thereby improving the technical performance and efficiency of computer-implemented information retrieval.

The term “system” refers to a combination of one or more hardware devices and software components that cooperatively perform information processing operations as described herein.

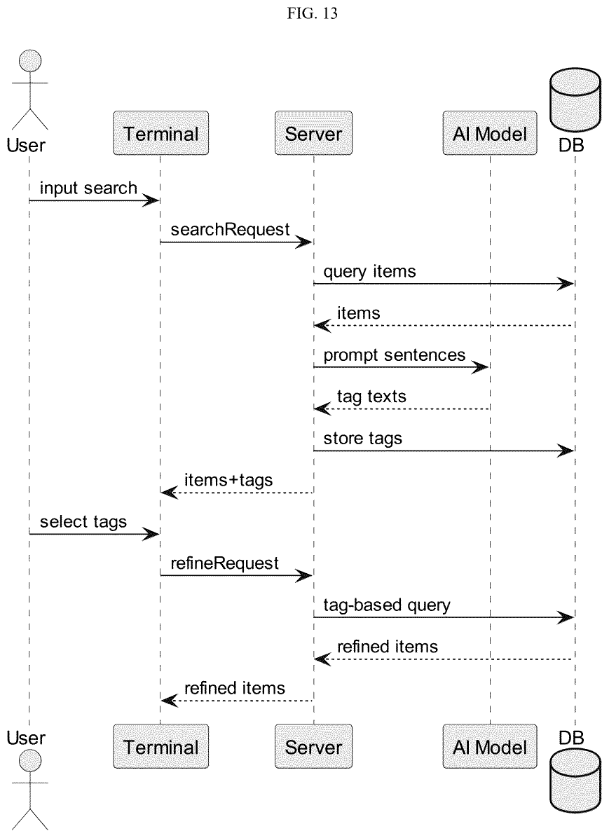

The term “processor” refers to one or more hardware processing units, such as a central processing unit or a graphics processing unit, configured to execute instructions stored in a memory to perform the functions described herein.
The term “communication interface” refers to a hardware and software interface, such as a network interface controller and associated protocol stack, that enables data exchange between the system and external devices or services over a communication network.
The term “user terminal” refers to an information processing device operated by a user, such as a personal computer, a tablet device, or a mobile communication device, that is configured to transmit requests to the system and receive and display responses.
The term “search request” refers to a message transmitted from the user terminal to the system that includes at least one search condition indicating a user's retrieval intention.
The term “search condition” refers to one or more data elements, such as keywords, categories, identifiers, or filters, that specify constraints or criteria to be applied during retrieval of information items.
The term “information storage device” refers to a non-transitory storage medium or a storage subsystem, such as a database system or a file storage system, configured to store structured information and unstructured information.
The term “structured information” refers to information stored in a predefined format or schema, such as records in a relational database table or entries in a key-value store, in which fields and data types are explicitly defined.
The term “unstructured information” refers to information that does not conform to a predefined schema, such as free-text documents, natural language descriptions, or image data.
The term “preprocessing” refers to a series of data transformation operations, such as parsing, tokenization, normalization, or formatting, performed on acquired information to generate input data suitable for processing by a generative AI model.
The term “input data” refers to data derived from structured information and unstructured information, formatted and arranged so that it can be provided as input to a generative AI model.
The term “generative AI model” refers to a machine learning model that generates text or other data in response to input data, by applying learned parameters to infer patterns and semantics, and that is capable of producing natural language output used in the present invention.
The term “prompt sentence” refers to a text sequence that includes at least one instruction to the generative AI model and at least a portion of the input data, and that is provided as a prompt to guide the generative AI model's output.
The term “request including the prompt sentence” refers to a communication message transmitted to the generative AI model via the communication interface, the message containing the prompt sentence and any associated parameters necessary for model inference.
The term “natural language text” refers to character data expressed in a human language, generated by the generative AI model as an analysis result of the input data.
The term “analysis result” refers to output produced by the generative AI model based on processing of the input data and the prompt sentence, including but not limited to summaries, descriptions, or extracted features.
The term “important expressions” refers to words, phrases, or other textual segments selected from the natural language text that represent salient features or characteristics of corresponding information items.
The term “normalize” refers to processing applied to important expressions to convert them into a standardized form, such as unifying letter case, removing redundant characters, and converting spaces to a consistent delimiter.
The term “identifier” refers to a normalized textual element, such as a keyword or tag, that represents at least one feature of an information item in a machine-actionable manner.
The term “group of identifiers” refers to a set or collection of two or more identifiers associated with a specific information item.
The term “information item” refers to a unit of information stored in the information storage device, such as a product record, a document entry, or another discrete data entity.
The term “store in association with” refers to recording data in the information storage device such that the data is logically or physically linked to one or more information items, for example via a shared key or reference.
The term “aggregate” refers to combining identifiers related to a common information item into a unified group or representation for subsequent processing or transmission.
The term “selectable display element” refers to a graphical user interface component, such as a button, chip, or checkbox, presented on the user terminal and configured to receive a selection input from the user.
The term “refinement request” refers to a message transmitted from the user terminal to the system indicating that the user has selected at least one identifier as an additional search condition to narrow or modify retrieval results.
The term “search process” refers to one or more operations executed by the processor to query the information storage device using specified conditions, and to identify information items that satisfy those conditions.
The term “search result” refers to data representing one or more information items retrieved by the search process, which is transmitted from the system to the user terminal.
The term “information medium” refers to a form in which information is represented, including but not limited to character information, image information, audio information, or video information.
The term “character information” refers to data composed of textual characters, such as alphanumeric strings or symbols, representing human-readable text.
The term “image information” refers to data representing visual content, such as raster images, vector graphics, or encoded image files.
The term “processing content” refers to operations or tasks that the generative AI model is instructed to perform, such as extracting features, generating identifiers, or summarizing content.
The term “output format” refers to a prescribed structure or style of the generative AI model's output, including rules on how identifiers or other text should be arranged, separated, or encoded.
The term “dynamically generate” refers to creating a prompt sentence or other data at runtime in response to current input data or context, rather than relying solely on a fixed, pre-stored template.
The term “search conditions” refers to identifiers or other parameters provided to the processor to constrain or guide retrieval of information items during the search process.
The term “additional prompt sentence” refers to a prompt sentence that is generated and transmitted to the generative AI model after an initial interaction, the additional prompt sentence including previously generated identifiers and at least one search condition.
The term “estimate” refers to generating, by the generative AI model, output that infers relationships, relevance, or additional identifiers based on provided input data and instructions.
The term “related information” refers to information items determined, based on identifiers or model output, to have a semantic or functional relationship to a current information item or search condition.
The term “additional refinement candidate” refers to an identifier or other filter condition proposed to the user as a further option for narrowing or adjusting search results.
In one embodiment, a server operates as a network-connected information processing apparatus that cooperates with one or more terminals to provide search and refinement functionalities based on identifiers generated by a generative AI model. The server includes at least one processor, a main memory, a non-transitory storage device such as a magnetic disk or solid-state drive, and a communication interface such as an Ethernet controller or wireless network interface. The server executes system software such as an operating system (for example, a UNIX-based OS) and middleware such as a web server and an application framework (for example, a framework comparable to Django, Spring, or Node.js-based frameworks). The server further accesses a database management system, such as a relational database, that stores structured information and unstructured information.
The server uses the database management system to store structured information as records in tables (for example, product tables having columns for identifiers, names, categories, and numerical attributes) and to store unstructured information such as long text fields and references to image files. The server represents each information item as a combination of structured fields and unstructured fields. The server stores, in the same or separate tables, a tag table in which each row associates a product identifier or other information item identifier with one textual identifier. The server uses indexing structures such as B-tree indexes or inverted indexes on tag columns to enable accelerated lookup based on identifiers.
The server configures the processor to execute an application program that generates prompt sentences and interacts with a generative AI model. In one embodiment, the server invokes a transformer-based generative AI model comparable to an autoregressive language model with multiple self-attention layers, residual connections, and layer normalization. The generative AI model stores parameters (weights) in tensors that define attention matrices and feed-forward network layers. The generative AI model uses a subword tokenizer to convert input prompt sentences into token sequences. The model computes, for each layer, attention scores between tokens, applies softmax normalization, and calculates context-aware token embeddings. The model then passes these embeddings through position-wise feed-forward networks and produces, via a final linear layer and softmax, a probability distribution over output tokens. The server configures the model to operate in a controlled generation mode in which the output is constrained to short, comma-separated tag strings.
The server stores the generative AI model either locally, as a model file in the storage device loaded into memory for inference by the processor, or remotely, as a model service accessible over a network via an application programming interface. In the latter case, the server uses a communication interface to send requests to the model service hosted on an AI inference platform. The server uses an HTTP-based protocol with encrypted transport. The server constructs a request that includes the prompt sentence and model parameters such as a maximum output length, temperature, and sampling strategy. The server receives a response that contains the generated natural language text representing identifiers.
The server uses clearly defined data structures to represent input data to the generative AI model. For textual information, the server concatenates multiple fields (for example, a product name and a product description) into a single text string. For image information, the server may store pre-computed embeddings generated by a separate vision model, and the server may convert such embeddings into a textual description phrase prior to inclusion in a prompt sentence, or the server may provide an image reference to a multimodal generative AI model. The server transforms these pieces of information into a linearized form that is included directly in the prompt sentence.
The server generates a prompt sentence for each information item or for groups of information items. The server embeds explicit instructions in the prompt sentence to specify the processing content and the output format. For example, the server generates one prompt sentence such as:
“Please extract this product's main selling points as 3-7 concise English keywords (tags) suitable for e-commerce filtering. Respond only with comma-separated tags. Product description: ‘Latest smartphone, 6.5-inch display, 5000 mAh battery, triple camera, 5G support.’”
   The server may generate another prompt sentence that emphasizes user-oriented features, such as:
“You are an assistant that generates feature tags for an online store. Read the following product description and output 3-7 short English tags that would help users filter products (for example, ‘long-battery-life’, ‘high-resolution-camera’). Respond only with comma-separated tags. Description: ‘A compact smartphone with 5.2-inch screen, 3000 mAh battery, dual camera, and affordable price.’”
   The server dynamically modifies the prompt sentences based on context, such as the type of information item, the domain (electronics, clothing, documents), or the user's search condition. By including explicit constraints and examples in the prompt sentences, the server causes the generative AI model to produce outputs in a machine-actionable format that is immediately usable as identifiers.
   The server performs normalization of generated text into identifiers using rule-based algorithms and data structures in memory. The server parses the text returned by the generative AI model, splits the text on delimiters such as commas, trims whitespace, removes prohibited characters, converts all letters to lowercase, replaces spaces with a consistent separator (such as hyphens), and eliminates duplicates by inserting identifiers into a set structure keyed by the identifier string. The server optionally applies stemming or lemmatization algorithms from a natural language processing library to unify semantically equivalent variants. The server then assigns each normalized identifier to the corresponding information item identifier and stores it in the tag table in the database. Through this normalization process, the server converts free-form natural language outputs of the generative AI model into a standardized, indexable representation.
   The server further configures the database to maintain indexes over identifiers and information item identifiers. The server uses these indexes during search operations to perform efficient join and filter operations. When the server receives a refinement request from a terminal, the server constructs database queries that use the identifiers as search keys. Because the identifiers are standardized and stored in indexed structures, the server reduces the number of rows scanned and minimizes disk I/O, thereby reducing response latency and CPU utilization. The server thus improves the technical performance of the overall search pipeline by transforming previously unstructured textual descriptions into structured identifier fields.
   The terminal operates as a client device such as a web browser application or a mobile application. The terminal includes a display unit, an input device such as a touch screen or keyboard, a local processor, and a communication module. The terminal receives lists of information items and associated identifiers from the server. The terminal uses a user interface toolkit to render each identifier as a selectable display element, such as a “chip” with a label, a button, or a checkbox. The terminal attaches event handlers to these display elements such that a user selection generates a refinement request. The terminal packages selected identifiers and optional additional search conditions as a message and transmits the message to the server via a communication channel. The terminal updates displayed content in response to new search results from the server, thereby providing an interactive refinement experience.
   The user interacts with the terminal by entering an initial search condition, such as a keyword or category selection, and by selecting identifiers displayed as selectable display elements.
   The user may refine search results iteratively by adding or removing identifiers. The user perceives improved relevance and reduced search time because the identifiers are derived automatically from detailed information items and are presented in a compact form that exposes discriminative features.
   The server, by coordinating with the generative AI model, achieves technical improvements in multiple respects. First, the server offloads high-dimensional semantic analysis to the generative AI model but constrains the outputs via carefully designed prompt sentences and normalization algorithms. This combination of generative model inference and deterministic post-processing enables the server to build an additional layer of structured metadata (identifiers) that did not exist in the raw data. Because the identifiers are standardized, the server can index them using conventional database mechanisms, allowing subsequent search operations to be executed with far fewer compute resources than would be required for repeated full-text semantic analysis.
   Second, the server reduces network traffic and compute redundancy by storing generated identifiers in the database and reusing them for subsequent search operations. Once an information item has been processed by the generative AI model and identifiers have been stored, the server is able to respond to many subsequent refinement requests solely by querying the local database, without invoking the generative AI model again. This reduces the number of calls to external AI services or local model inference processes, decreasing latency, bandwidth consumption, and energy usage.
   Third, the server improves ranking accuracy and filtering precision by employing identifiers that encode higher-level semantic features than raw keywords. Because the generative AI model internally uses multi-head attention mechanisms and learned embeddings to capture relationships between words and phrases, the identifiers reflect complex combinations of attributes that are difficult to capture with simple rule-based extraction. However, the server does not rely on opaque model decisions alone; instead, the server enforces formatting and normalization rules and integrates the identifiers into transparent query logic. This hybrid approach leverages the representational power of the generative AI model while maintaining deterministic behavior in the search subsystem.
   Fourth, the server configures the generative AI model using a training methodology that further contributes to technical improvements. During pre-training, a large corpus of domain-relevant text is used, and the model parameters are optimized using gradient-based optimization with a loss function such as cross-entropy over predicted tokens. During fine-tuning, the server or an associated training system provides examples of product descriptions with desired identifiers. The training system adjusts the model weights to minimize the difference between the generated identifiers and the target identifiers. Data augmentation techniques such as synonym substitution, random reordering of non-critical phrases, and masking of numerical values are used to increase robustness. As a result, the generative AI model becomes more stable and accurate when generating identifiers, and the server benefits from lower error rates and fewer misaligned tags in production.
   In some embodiments, the server uses a multi-stage inference pipeline. The server first invokes a smaller, faster model to generate a preliminary set of candidate identifiers. The server then applies deterministic filtering based on domain rules (for example, removing overly generic words or enforcing domain-specific patterns). The server optionally invokes a larger, more accurate generative AI model only when the preliminary output fails to meet confidence thresholds or structural constraints. By integrating confidence estimation and conditional invocation logic, the server balances accuracy and efficiency and improves average response time for users.
   The server employs specific data flows and module configurations to realize these improvements. The server logically divides components into a request handling module, a data retrieval module, a prompt generation module, a model interaction module, a post-processing module, and a tag-based search module. Each module uses well-defined input and output data structures, such as objects representing information items, prompt sentences, raw model outputs, and normalized identifier lists. The server ensures that processing occurs in a pipeline manner, with intermediate results stored in memory structures optimized for sequential access and batch operations. For example, the server may accumulate multiple information items into a batch before sending prompt sentences to the generative AI model, thereby reducing network overhead and amortizing model initialization costs.
   In another embodiment, the server uses an internal generative AI model rather than an external service, and the processor executes the model directly on a hardware accelerator such as a graphics processing unit or tensor processing unit. The server loads the model weights into device memory and performs batched inference. The server organizes input token sequences into matrices to exploit vectorized operations. This configuration further reduces model inference time and allows the system to handle higher query volumes without linear increases in hardware resources.
   In yet another embodiment, the server sends additional prompt sentences that include both previously generated identifiers and a current search condition. The server instructs the generative AI model to output related identifiers or related item descriptions. For example, the server may use a prompt sentence such as:
“Given the following selected tags: ‘long-battery-life’, ‘triple-camera’, and the query term ‘smartphone’, suggest 3-7 additional feature tags that are semantically related and useful for refining a product search. Respond only with comma-separated tags.”
   The server uses the additional identifiers proposed by the generative AI model to extend the search space or to present additional refinement options on the terminal. The server thus enables a form of intelligent facet expansion that is not achievable by fixed, manually defined taxonomies. Because this process is driven by model-inferred relationships encoded in the model's high-dimensional embedding space, the system can discover non-obvious affinities between features while still preserving deterministic control at the level of identifier storage and query construction.
   The technical effects of these embodiments are concrete and measurable. The server reduces the average number of disk reads per query by using identifier indexes instead of scanning full text fields. The server reduces end-to-end latency by avoiding repeated semantic analysis for the same information items. The server lowers memory usage per query by working with compact identifier strings rather than long natural language descriptions. The server improves search precision, as measured by metrics such as precision at k or recall at k, because identifiers generated by the generative AI model capture more informative aspects of products or documents than raw keywords alone. These effects arise from the specific combination of prompt-driven generative AI processing, normalization into identifiers, storage in indexed data structures, and interactive refinement via terminals, and are not obtained by mere human manual tagging or generic automation.
   The terminal and the user remain integral to the system, but the improvements are rooted in computer-internal operations, including data structure design, AI model configuration, and database query optimization. The user benefits from faster, more accurate, and more controllable search behavior, while the underlying computing infrastructure operates more efficiently and with enhanced technical capabilities.
   The following describes the processing flow using FIG. 13.

### Step 1:

The terminal transmits an initial search request to the server.
The terminal receives a user input such as a keyword, a category selection, or a combination thereof through an input device. The terminal constructs a request message that includes the search condition, a user identifier, and optional context information (for example, locale or device type). As input, the terminal uses the raw user input and the current UI state; as output, the terminal generates a structured request object and sends it to the server via a communication interface using an HTTP or HTTPS protocol.

### Step 2:

The server parses the search request and derives retrieval parameters.
The server receives the request message from the terminal as input. The server uses an application framework to parse URL parameters and request bodies, extracts the search condition, and validates parameter types and lengths. The server converts the raw search condition into internal retrieval parameters, such as a normalized keyword string, a target domain (for example, product domain), and pagination information. As output, the server produces a retrieval parameter set that is passed to a data access module.

### Step 3:

The server retrieves structured and unstructured information from the information storage device.
The server uses the retrieval parameter set as input to construct database queries. The server generates, for example, a SQL statement that selects product identifiers, names, categories, text descriptions, and image references from one or more tables, optionally applying conditions based on the search keyword or category. The server executes the query against a relational database engine, which returns records as row sets. The server then converts each row into an internal object containing structured fields (identifiers, numerical attributes) and unstructured fields (long text, image paths). As output, the server obtains a collection of information item objects that represent candidate results for further processing.

### Step 4:

The server aggregates raw item data into input data for a generative AI model.
The server takes the collection of information item objects as input. For each object, the server concatenates relevant text fields (such as name and description) into a single text string and, if available, appends textual metadata derived from images (such as alt text or captions).
The server may also include selected structured attributes (for example, “battery: 5000 mAh”, “display: 6.5 inch”) converted into human-readable phrases. The server performs preprocessing, including removing control characters, normalizing whitespace, and truncating overly long text while preserving important tokens. As output, the server generates, for each information item, a cleaned, normalized text description that will be embedded into a prompt sentence.

### Step 5:

The server generates a prompt sentence for each information item.
The server uses the normalized text description of each information item as input. The server combines this text with a fixed instruction template that specifies the desired processing content and output format for the generative AI model. For example, the server constructs:
“Please extract this product's main selling points as 3-7 concise English keywords (tags) suitable for e-commerce filtering. Respond only with comma-separated tags. Product description: ‘[normalized description]’.”
   The server performs string concatenation and placeholder replacement to embed the actual description into this template. As output, the server produces a prompt sentence associated with each information item identifier.

### Step 6:

The server sends the prompt sentences to the generative AI model and requests inference.
The server takes as input a batch of prompt sentences and associated item identifiers. The server builds a request payload containing these prompt sentences and configuration parameters (maximum tokens, temperature, sampling strategy). The server uses an HTTP client library to send this payload to a generative AI model endpoint via the communication interface. The server may group multiple prompt sentences into a single batch request to reduce network overhead. As output, the server transmits the request to the generative AI model and initiates an asynchronous wait for responses.

### Step 7:

The generative AI model generates natural language outputs based on the prompt sentences.
The generative AI model receives the batch of prompt sentences as input. The model tokenizes each prompt, encodes tokens into embeddings, and passes them through multiple transformer layers composed of multi-head self-attention and feed-forward sublayers. The model computes attention weights across tokens to capture relationships between instruction parts and description parts and then predicts output tokens sequentially using an autoregressive decoding process. The model is configured to stop generation when a predefined token limit or end-of-sequence token is reached. As output, the model returns a list of generated texts, each intended to be a short, comma-separated list of tags corresponding to one prompt sentence.

### Step 8:

The server receives and parses the natural language outputs from the generative AI model.
The server uses the HTTP client to receive the model's response as input. The server extracts, for each prompt, the generated text field containing the tag string. The server then parses this string by splitting on commas, trimming whitespace around each segment, and discarding any empty segments. As output, the server obtains, for each information item identifier, an intermediate list of raw tags as plain strings.

### Step 9:

The server normalizes and deduplicates the tags into identifiers.
The server uses each item's raw tag list as input. The server applies normalization rules, including converting all characters to lowercase, replacing spaces with hyphens, removing non-alphanumeric characters except for separators, and optionally applying stemming or lemmatization to unify variants. The server inserts each normalized tag into a set structure keyed by the tag string to automatically remove duplicates. The server may also filter out stop-words or overly generic tokens based on a pre-defined rule list. As output, the server generates, for each information item, a group of normalized identifiers suitable for indexing and search.

### Step 10:

The server stores the identifiers in association with corresponding information items.
The server takes as input the groups of normalized identifiers and the corresponding information item identifiers. The server constructs database insert or update statements that populate a tag table, where each row links an item identifier to one identifier string. The server executes these statements against the database engine, which updates persistent storage and associated indexes. The server may also update in-memory caches for frequently accessed items. As output, the server maintains an updated mapping from information items to identifiers within the information storage device.

### Step 11:

The server constructs a response containing items and their identifiers and sends it to the terminal.
The server uses the retrieved information items and the newly stored identifiers as input. The server queries the tag table or in-memory structures to collect the group of identifiers for each item. The server builds a response object that includes, per item, a subset of fields (such as name, image reference) and the associated identifiers. The server serializes this object into a transferable format such as JSON and sends it via HTTP or HTTPS to the terminal. As output, the server issues a response message enabling the terminal to render identifiers as selectable display elements.

### Step 12:

The terminal renders information items and identifiers as selectable display elements.
The terminal receives the response message from the server as input. The terminal parses the payload to reconstruct item objects and identifier lists. The terminal uses a user interface library to generate visual components for each item (for example, cards with title and image) and for each identifier (for example, chips or buttons labeled with the identifier text). The terminal binds click or tap event handlers to these components so that user interactions can be captured. As output, the terminal displays a screen in which identifiers appear as selectable display elements associated with corresponding items.

### Step 13:

The user selects one or more identifiers to refine the search.
The user views the displayed items and identifiers as input to the user's decision-making process. The user taps or clicks on one or more identifiers that represent desired features or constraints. The user's actions are captured by the terminal's event handlers, which update the local UI state to mark selected identifiers and optionally show them in a dedicated filter area. As output, the user causes the terminal to prepare a refinement request containing the selected identifiers.

### Step 14:

The terminal sends a refinement request including selected identifiers to the server.
The terminal uses the current UI state, including the set of selected identifiers and any existing search conditions, as input. The terminal constructs a structured message that includes a list of identifier strings, the original or updated keyword, and pagination or sorting preferences. The terminal transmits this message to the server using HTTP or HTTPS. As output, the terminal delivers a refinement request that instructs the server to re-execute a search based on the selected identifiers.

### Step 15:

The server executes a tag-based search using the selected identifiers.
The server receives the refinement request as input and extracts the list of selected identifiers.
The server constructs database queries that join the item table with the tag table and constrain results to items whose associated identifiers match all or a subset of the selected identifiers.
The server uses indexed columns on the tag table to restrict the search space and reduce scan operations. The server executes the queries, obtains matching item rows, and converts them into item objects. As output, the server generates a refined set of information items that satisfy the selected identifiers.

### Step 16:

The server returns the refined search results to the terminal.
The server takes the refined item set as input and builds a response containing item summaries and, optionally, their identifiers. The server again serializes this information and sends it back to the terminal via the communication interface. As output, the server provides a new result set tailored to the user's selected identifiers.

### Step 17:

The terminal updates the display to show the refined results to the user.
The terminal receives the refined result set as input and parses it into item objects. The terminal replaces or updates the list of displayed items, removing those that no longer satisfy the refinement conditions and adding those that are newly included. The terminal may highlight active identifiers or provide controls to clear or modify them. As output, the terminal presents an updated interface reflecting the refined search results and enabling the user to continue interactive refinement if desired.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information retrieval and recommendation systems typically rely on static keyword indexing and rule-based filtering executed by generic search engines. In such systems, a server often treats textual data and image data separately, and does not generate compact, semantically meaningful identifiers that can be consistently used across heterogeneous content types. As a result, when a user issues a search request, the server tends to return a large set of loosely related items that are difficult to navigate, and the user terminal must render verbose titles and descriptions that burden both network bandwidth and user interface resources.

Further, in many existing architectures, the server uses pre-defined query templates rather than dynamically generated prompt sentences to interact with machine learning components. When a generative model is used at all, it is typically applied off-line or only for coarse summarization, without an integrated loop that converts the model's outputs into normalized identifiers stored as structured data. Consequently, the system cannot efficiently exploit generative outputs as first-class index keys for subsequent refinement, ranking, or cross-modal fusion of text and image features.
In addition, known systems often fail to incorporate user behavior signals or emotion-related information into the same computational pipeline that generates and applies identifiers. Emotion estimation, when present, is architected as an external overlay that only biases recommendations at a superficial level, without being explicitly encoded into prompt sentences for a generative model or into the underlying identifier set. This separation limits the system's ability to adapt ranking and filtering logic to real-time user state within the same computational framework that defines the semantic representation of content.
From a computer-technology perspective, these limitations lead to several technical problems: (i) inefficient use of processing resources on the server, because text, images, and user state are processed in isolated modules without unified representations; (ii) suboptimal data structures on storage and retrieval devices, because identifiers are not systematically generated and normalized across modalities; (iii) increased latency and network load, because the server must transmit large, unstructured payloads instead of compact identifier-based structured data; and (iv) constrained user interaction models on the terminal, because the terminal cannot leverage machine-generated, semantically rich identifiers as stable handles for dynamic refinement and navigation.
Accordingly, there is a need for a computer-implemented system that integrates prompt-sentence generation, generative AI model invocation, linguistic and image analysis, and emotion-aware refinement into a coherent processing pipeline. Such a system should generate normalized identifier sets from both textual and visual content, store those identifier sets as structured data in association with items, and use them as primary control variables for search refinement, recommendation, and user interface rendering. By re-architecting the server and terminal interactions around these identifier sets and prompt-controlled generative processing, the system should improve computational efficiency, retrieval accuracy, and the responsiveness of the user interface, thereby achieving a concrete improvement in computer functionality rather than merely automating a mental process.
The specific processing by the specific processing unit 290 of the data processing device 12 in Application Example 2 is realized by the following means.

The present invention provides a server comprising a processor configured to receive, from a user terminal, search requests or imaging data and to acquire related information from a storage device or a retrieval device based on the search requests, to preprocess character information and image information included in the acquired information so as to generate analysis target data, to generate prompt sentences including the analysis target data and to input the prompt sentences to a generative AI model in order to obtain response data including summaries and feature terms of the information, to extract a plurality of identifier candidates from the response data and to generate, by linguistic analysis processing and image analysis processing, normalized and integrated identifier sets representing features of the information or item information, to store the identifier sets as structured data in association with titles, description sentences, and images of the information or the item information, to transmit the structured data including the identifier sets to the user terminal so as to cause the user terminal to present the identifiers as selectable display elements, and to receive, from the user terminal, refinement requests based on selected identifiers and to extract, based on the identifier sets, related information or item information and to transmit refined search results to the user terminal. This enables the computing system to convert heterogeneous content and user interaction signals into unified, machine-generated identifier sets that reduce payload size, improve indexing and retrieval efficiency, and allow the user terminal to perform fine-grained, low-latency refinement and navigation operations, thereby achieving a technical improvement in overall computer performance and user interface responsiveness.

The term “processor” refers to a hardware or virtual execution unit, such as a central processing unit or a processing core, that executes computer-readable instructions to perform the operations described in the present disclosure.
The term “user terminal” refers to any computing apparatus operated by a user, such as a mobile terminal, a desktop terminal, or a tablet device, that transmits requests to a server and presents information to the user.
The term “search request” refers to electronic query data including at least one search term, condition, or filter, which is transmitted from a user terminal to a server to request retrieval of related information or item information.
The term “imaging data” refers to digital image information, including still images or moving images, captured by an image acquisition component of a user terminal or acquired from a storage resource, and transmitted to a server for analysis.
The term “storage device” refers to a data storage resource, such as a database system or a file storage system, that stores information, item information, and structured data accessible by a server.
The term “retrieval device” refers to a search or indexing resource, such as a search engine or an index server, that executes retrieval operations over stored data in response to search requests from a server.
The term “related information” refers to information items, such as documents, records, or content objects, that are determined by a retrieval device or a storage device to be relevant to a search request.
The term “item information” refers to structured or semi-structured data that describes an item, such as a product, service, or content entity, including attributes such as a title, a description, an image link, and other associated metadata.
The term “character information” refers to machine-readable text data, including natural language text, alphanumeric strings, and symbols contained in documents, records, or item information.
The term “image information” refers to pixel data, feature data, or other representations of visual content obtained from imaging data or from image fields associated with item information.
The term “analysis target data” refers to processed data derived from character information and image information, formatted and prepared by a server to be input to a generative AI model or to auxiliary analysis components.
The term “prompt sentence” refers to a text sequence, including instructions and contextual information, constructed by a server and provided as input to a generative AI model to control the model's processing and output behavior.
The term “generative AI model” refers to a machine learning model, such as a generative language model, configured to receive prompt sentences and produce output text that includes summaries, feature terms, or other generated content.
The term “response data” refers to output data generated by a generative AI model in response to a prompt sentence, including at least one of a summary, feature terms, or other generated text.
The term “summary” refers to a condensed textual representation of the semantic content of information or item information, generated by a generative AI model based on analysis target data.
The term “feature terms” refers to textual expressions, such as words or short phrases, that represent salient characteristics or attributes of information or item information.
The term “identifier candidate” refers to a candidate label or term extracted from response data that is considered for inclusion in an identifier set representing features of information or item information.
The term “identifier set” refers to a collection of normalized and integrated identifiers, each identifier being a textual label that characterizes one or more features of corresponding information or item information.
The term “linguistic analysis processing” refers to computational processing applied to text, including tokenization, normalization, part-of-speech tagging, or other natural language processing operations, used to refine and normalize identifier candidates.
The term “image analysis processing” refers to computational processing applied to image information, including object detection, feature extraction, or visual label generation, used to derive or refine identifiers.
The term “normalized and integrated” refers to a state in which identifiers have been processed to remove duplicates, harmonize formats, and combine related terms so that a consistent identifier set is established for each information item.
The term “structured data” refers to data organized according to a defined schema, such as key-value pairs, records, or objects, in which titles, description sentences, images, and identifier sets are associated in a machine-readable form.
The term “title” refers to a text string that identifies or names information or item information and is suitable for display as a heading in a user interface.
The term “description sentence” refers to one or more sentences of text that explain or describe the content or characteristics of information or item information.
The term “selectable display element” refers to a user interface component, such as a clickable label, tag, or button, that presents an identifier and accepts user input to trigger refinement or navigation operations.
The term “refinement request” refers to electronic request data generated by a user terminal in response to user selection of one or more identifiers, instructing a server to narrow or reorder retrieved information or item information based on the selected identifiers.
The term “image processing unit” refers to hardware or software configured to perform image analysis processing on image data, including extraction of visual feature information.
The term “visual feature information” refers to data representing visual characteristics detected from image data, including object categories, colors, shapes, or styles derived by image analysis processing.
The term “behavior information” refers to data indicating user interactions with a user terminal or system, such as click logs, selection patterns, viewing durations, or navigation paths.
The term “biometric information” refers to data derived from physiological or behavioral characteristics of a user, such as facial expression data, voice characteristics, or other measurable body-related signals.
The term “emotion estimation processing” refers to computational processing that analyzes behavior information or biometric information to infer an emotion state of a user.
The term “emotion state” refers to a classification or representation of a user's emotional condition, such as joy, surprise, neutrality, or other affective categories, inferred by emotion estimation processing.
The term “emotion analysis processing” refers to processing operations, implemented by software or hardware, that determine an emotion state based on one or more types of user-related input data.
The term “proposal content of related information” refers to generated or selected information items that are determined, based on an emotion state and identifier sets, to be suitable for recommendation or presentation to a user.
The term “individualized related information” refers to related information that has been selected, ranked, or generated in accordance with an individual user's emotion state, preferences, or interaction history, as reflected in identifier sets and other user-specific data.

The server implements the claimed system as a network-accessible computing platform including at least one processor, a main memory, a non-volatile storage device, a network interface, and optional hardware accelerators such as a graphics processing unit. The server executes an operating system and one or more application programs that realize the functions of retrieval, preprocessing, prompt sentence generation, generative AI model interaction, linguistic analysis, image analysis, identifier set generation, emotion estimation, and structured-data management. The terminal implements a user-side computing apparatus, such as a mobile terminal, a desktop terminal, or a tablet device, including an input device, a display device, an image acquisition component, and a communication interface.

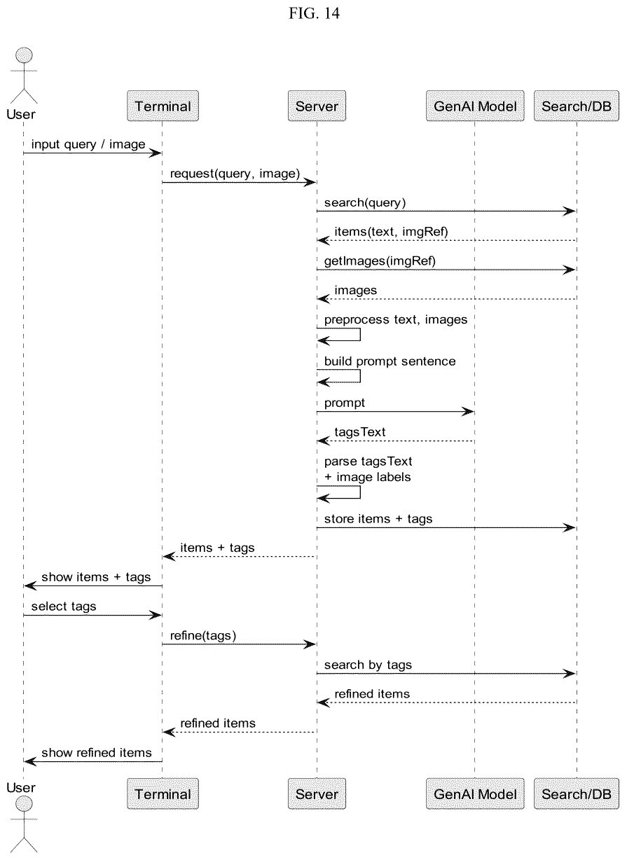

The server uses a layered software architecture. In one embodiment, the server uses a web application framework implemented on a general-purpose programming language, a search engine framework that provides index and retrieval functionality, a natural language processing library such as a tokenization and part-of-speech tagging library, an image processing library such as a computer-vision library, and a machine learning runtime framework such as a tensor-based numerical computation library. The server also uses a generative AI model hosting environment, in which a generative language model is provided as a remote service or an on-premise inference engine.
The server stores information and item information in a storage device as structured records. Each record includes at least a title field, a description field, an optional image reference field, and an identifier set field. The identifier set field is defined as a collection of string values representing normalized identifiers generated according to the present invention. The server additionally stores per-record metadata such as category, timestamp, and quality score for use in ranking and refinement.
The server preprocesses character information by converting input text to a canonical encoding, normalizing whitespace, removing markup tags, and applying tokenization. The server uses a natural language processing library to split text into tokens, assign part-of-speech tags, and detect sentence boundaries. The server may also apply lemmatization or stemming to reduce inflected forms to base forms. The server stores intermediate representations of text as token sequences and lemma sequences in memory structures optimized for subsequent analysis.
The server preprocesses image information by decoding image data from standard formats into in-memory matrices of pixel values. The server uses an image processing library to resize images to a fixed resolution, normalize pixel intensities, and optionally perform color-space conversions. In some embodiments, the server computes low-level feature maps through convolutions with learned or predefined kernels, generating activation tensors that serve as inputs to deeper neural network layers.
The server generates analysis target data by combining preprocessed character information and image information. For textual content, the server concatenates title and description fields into a single string, optionally truncated to a predetermined maximum character length. For visual content, the server passes preprocessed images through a feature extraction network to obtain a feature vector representing visual characteristics. The server constructs analysis target data objects that contain both textual sequences and associated visual feature vectors.
The server constructs a prompt sentence by embedding analysis target data into a predefined instruction template. For example, the server uses a text template such as:
“You are a tagging assistant for an information retrieval system. Read the following title and description, and output 3 to 7 short, semantically distinct keywords that represent the main features of the content. Use comma-separated English phrases, without explanatory sentences. Title: ‘‘Description: ’’”
   In a further embodiment, the server constructs a prompt sentence that additionally reflects visual features, such as:
“You are a tagging assistant for an image and text database. The item has the following visual characteristics: ‘‘. Read the following title and description, and output 3 to 7 short keywords that best describe both the textual and visual characteristics. Output only comma-separated keywords.”
   The server uses the generative AI model as a conditional text generator controlled by such prompt sentences. In one embodiment, the generative AI model is a transformer-based neural network with multiple self-attention layers, feedforward sublayers, and positional encodings. The generative AI model includes an embedding layer that maps input tokens to continuous vectors, a stack of attention blocks that compute context-dependent representations, and an output projection layer that produces probability distributions over vocabulary tokens at each time step.
   The server trains or fine-tunes the generative AI model on a training corpus containing pairs of input prompts and desired output tags. During training, the server defines an objective function such as a categorical cross-entropy loss between predicted tokens and reference tokens. The server updates model weights using a gradient-based optimization algorithm, such as stochastic gradient descent with momentum or an adaptive learning-rate method. The server may apply regularization techniques such as dropout, weight decay, and data augmentation; for instance, the server augments textual inputs by paraphrasing descriptions and augments image-derived features by applying spatial transformations before feature extraction.
   The server executes inference by sending tokenized prompt sentences to the generative AI model and receiving output token sequences. The server configures decoding parameters such as maximum output length, sampling temperature, and top-k or nucleus-sampling thresholds to control diversity and stability of generated feature terms. The server receives response data that includes sequences of tokens representing candidate identifiers.
   The server extracts identifier candidates by parsing response data. When the generative AI model returns comma-separated phrases, the server splits the response string at comma boundaries and trims whitespace. The server applies linguistic analysis processing to each candidate. The server uses tokenization, part-of-speech information, and named-entity recognition to filter out stop words, overly generic adjectives, and incomplete fragments. The server may combine adjacent tokens into multi-word phrases when a phrase boundary is indicated in the prompt or by punctuation.
   The server executes image analysis processing to generate visual labels. In one embodiment, the server uses a convolutional neural network trained for image classification and object detection. The network includes convolutional layers, pooling layers, and fully connected layers, with weights learned using a classification loss over a predefined label set. The server inputs preprocessed images to this network and obtains class probabilities for labels such as object type, dominant color, and usage context. The server selects labels whose probabilities exceed a threshold and converts them into textual feature terms.
   The server normalizes and integrates identifier candidates by applying a pipeline of operations. The server converts all identifiers to a base form, such as lowercase and singular noun form, using a lemmatizer. The server removes duplicate identifiers and merges semantically equivalent identifiers by consulting a synonym mapping table or by computing vector similarity in an embedding space. The server discards identifiers that fail a specificity threshold, which is computed based on global frequency statistics in the storage device. The result of this pipeline is an identifier set that compactly and consistently expresses core features of the information or item information.
   The server stores the identifier set as part of structured data. The server maintains a schema in a relational or document-oriented database in which each record includes fields for the title, description, image reference, and identifier set. The identifier set is stored in a dedicated column or key as an array or set type, indexed by an inverted index in the retrieval device. By indexing identifier sets, the server allows subsequent refinement queries to be executed as efficient set-membership or weighted-match operations.
   The terminal receives structured data containing identifier sets and constructs user interface elements that bind each identifier to an interactive component. The terminal displays identifiers near the title and image of each item as selectable display elements, such as tags or chips. When the user selects a display element corresponding to an identifier, the terminal generates a refinement request that includes the selected identifiers as part of request parameters. The server receives this refinement request and maps selected identifiers to queries against identifier set indices in the retrieval device.
   The server uses identifier sets not only as display labels but also as primary keys for filtering and ranking. Because the identifier sets are normalized and integrated across textual and visual modalities, the retrieval device can perform more precise and efficient matching than traditional full-text search. The server can compute scores for items based on exact matches, partial matches, or similarity in identifier-space, rather than relying solely on term frequency in unstructured text. This structured approach reduces the size of query result sets and the amount of data transmitted to the terminal.
   The server optionally executes emotion estimation processing using behavior information and biometric information acquired from the terminal. The terminal may capture facial images via its image acquisition component or log detailed interaction patterns such as dwell time on items and scroll behavior. The server uses an emotion analysis module, which may be implemented as a neural network classifier that receives facial feature vectors or behavioral feature vectors and outputs an emotion state label. The classifier may be trained with supervised learning, using a loss function that penalizes misclassification of emotion categories.
   The server incorporates the emotion state into prompt sentences for the generative AI model. For example, the server constructs a prompt sentence such as:
“The user is currently in an excited and curious mood. Based on the following identifiers and item description, suggest additional keywords that reflect attractive features for this emotion state.”
   By including emotion information in prompt sentences, the server guides the generative AI model to produce identifiers and proposal content of related information that better align with user state. The server also uses the emotion state and identifier sets as joint inputs to ranking algorithms, so that items associated with identifiers historically preferred under similar emotion states are prioritized.
   The system provides a technical improvement in computer functionality through these structures and processes. Because the server converts heterogeneous content into compact identifier sets, the server can reduce the payload size of responses transmitted to the terminal. This reduces network bandwidth consumption and enables faster response times. The use of structured identifier sets and dedicated indices in the retrieval device allows the server to execute refinement queries using efficient set operations and index lookups, which decreases CPU load and improves scalability. The integration of generative AI outputs, linguistic analysis, and image analysis into a unified pipeline leads to more accurate and stable identifiers, which improves retrieval precision and reduces error rates in recommendation.
   The server uses specific neural network architectures and training methods that differ from manual tagging or rule-based keyword assignment. For example, the generative AI model applies multi-head self-attention to capture long-range dependencies in text, which cannot be replicated by simple keyword extraction heuristics. The image analysis network detects objects and visual attributes at multiple scales, enabling the server to generate identifiers that reflect detailed visual aspects beyond human-defined categories. The normalization and integration pipeline uses statistical thresholds and embedding-based similarity measures that represent a machine-centered rule set for deciding which identifiers are preserved or merged, rather than simply encoding human judgment.
   The server thereby implements non-conventional and non-generic data processing flows. Instead of directly presenting raw search results, the server re-encodes content into identifier-space representations and makes those representations central to both retrieval and user interaction. This architecture results in measurable improvements in processing speed and retrieval accuracy. For instance, when the server uses identifier indices, query evaluation time can scale with the number of identifiers rather than the total document length, and the number of bytes transmitted per item to the terminal can be significantly reduced by transmitting identifiers instead of entire descriptions.
   Alternative embodiments are possible within the same inventive framework. The server may host the generative AI model locally rather than relying on a remote service, in which case the server deploys a trained transformer model on a machine learning runtime and executes inference using local hardware accelerators. The server may also employ different neural network architectures for image analysis, such as residual networks or vision transformers, while still using the resulting labels as part of the identifier set. The server may adjust the structure of identifier sets to include confidence scores or sub-category labels, and may use learning-to-rank models that operate on identifier features and emotion-state features.
   The terminal may implement different user interface layouts for presenting identifiers, such as grouping identifiers by type or modality, or displaying identifiers as sliders or toggle switches instead of simple tags. The user may interact with identifiers through gesture input or voice commands. The server may store and update user-specific preference profiles based on identifier selections, and use these profiles as additional features in the generative AI prompts or in ranking functions.
   In all such embodiments, the core technical concept remains that the server generates, manages, and applies normalized identifier sets derived through a coordinated use of prompt-controlled generative AI models, linguistic analysis, and image analysis, and that the terminal exposes these identifier sets as primary controls for user interaction. This combination yields a concrete and repeatable improvement to the way the computer system stores, indexes, retrieves, and displays information, and is not merely a restatement of a human mental process or a generic automation of business logic.
   The following describes the processing flow using FIG. 14.

### Step 1:

The user operates the terminal to input a search query or to capture an image.
The terminal receives, as input, character data from a text input widget or pixel data from an image acquisition component.
The terminal converts the character data into a request payload, for example a structured object containing a query string and optional filter fields, and converts the pixel data into an encoded image file or binary stream.
The terminal outputs a network request that includes the query and/or the image data and transmits this request to the server via a communication interface.

### Step 2:

The server receives the network request from the terminal.
The server takes, as input, the request payload containing the query string, optional user identifiers, and optionally one or more image files.
The server parses the request headers and body using a web application framework, validates parameter formats, and logs metadata such as timestamp and source address.
The server outputs internally normalized request data consisting of a clean query string, a list of image objects, and associated user context.

### Step 3:

The server retrieves candidate information or item information based on the query.
The server receives, as input, the normalized query string and optional user context from Step 2.
The server constructs a retrieval query to a retrieval device, specifying target indices and fields such as titles, descriptions, and image references, and submits this query over an internal interface.
The server outputs a set of candidate records including text fields and image references that are judged related to the input query.

### Step 4:

The server loads and preprocesses character information from the candidate records.
The server takes, as input, titles and description sentences from each candidate record.
The server performs data processing including character encoding normalization, removal of markup tags, whitespace normalization, and splitting into sentences and tokens by using a natural language processing library.
The server outputs preprocessed text sequences for each record, stored as token lists and clean text strings.

### Step 5:

The server loads and preprocesses image information associated with the candidate records.
The server receives, as input, image references or image files linked to the candidate records.
The server resolves image references, loads the image files into memory, decodes them into pixel matrices, resizes them to a fixed resolution, and normalizes pixel values using an image processing library.
The server outputs normalized image tensors or matrices ready for downstream analysis.

### Step 6:

The server generates analysis target data objects combining text and image features.
The server takes, as input, the preprocessed text sequences from Step 4 and the normalized image data from Step 5.
The server concatenates the title and description into a single text string, truncates the string if necessary to a maximum length, and optionally computes simple text features such as length and term frequencies; in parallel, the server may pass the normalized image data through a feature extractor network to obtain a compact feature vector.
The server outputs analysis target data for each candidate record, each object containing at least a consolidated text segment and optionally an image feature representation.

### Step 7:

The server constructs a prompt sentence for a generative AI model.
The server receives, as input, each analysis target data object containing text and optional image features.
The server embeds the text and summary of image features into a predefined instruction template, for example: “You are a tagging assistant for an information retrieval system. Read the following title and description, and output 3 to 7 short, semantically distinct keywords that represent the main features of the content. Use comma-separated English phrases, without explanatory sentences. Title: ‘‘Description:’’.”
The server outputs, for each record, a complete prompt sentence string that can be supplied to the generative AI model.

### Step 8:

The server invokes the generative AI model with the constructed prompt sentence.
The server takes, as input, the prompt sentence generated in Step 7 and model configuration parameters such as maximum output tokens and sampling parameters.
The server tokenizes the prompt sentence, encodes it into numerical token IDs, and transmits these IDs to the generative AI model via an inference interface; the underlying model executes attention-based computations to generate output tokens conditioned on the prompt.
The server outputs response data in the form of a generated text string containing candidate feature terms, such as comma-separated keywords.

### Step 9:

The server extracts identifier candidates from the response data.
The server receives, as input, the generated text output from the generative AI model in Step 8.
The server performs data processing by splitting the string at delimiters such as commas, trimming surrounding whitespace, and discarding empty segments; the server then analyzes each segment with a linguistic analysis library to detect language patterns and remove non-informative tokens.
The server outputs a list of textual identifier candidates for each candidate record.

### Step 10:

The server performs image analysis processing to obtain visual labels.
The server takes, as input, the normalized image data from Step 5.
The server feeds each image into an image analysis network or an image processing unit, which applies convolution and pooling operations to compute feature maps and then classifies the image into one or more label categories, such as object type and color; the server filters the resulting labels by thresholding their confidence scores.
The server outputs a set of visual labels for each image, expressed as human-readable feature terms.

### Step 11:

The server normalizes and integrates textual and visual identifier candidates.
The server receives, as input, the textual identifier candidates from Step 9 and the visual labels from Step 10.
The server converts all candidates to a canonical form, such as lowercase lemmas, and removes duplicates; the server computes similarity between candidates using an embedding-based distance or a synonym table and merges terms that are semantically equivalent, while removing overly generic terms based on global frequency statistics.
The server outputs a normalized identifier set for each record, representing a unified list of identifiers derived from both text and image data.

### Step 12:

The server associates the identifier set with structured record data and stores it.
The server takes, as input, the identifier set from Step 11 and the original record fields such as title, description, and image reference from Step 3.
The server constructs a structured data object following a predefined schema where the identifier set is placed into an array or set field, then writes this object into a storage device and updates retrieval indices so that each identifier is linked to corresponding records.
The server outputs updated stored records and index entries that incorporate the newly generated identifier sets.

### Step 13:

The server prepares a response payload for the terminal including identifier sets.
The server receives, as input, the stored records enriched with identifier sets from Step 12 and contextual information about the original user query.
The server selects a subset of records to return, formats each record into a response structure containing title, truncated description, image reference, and the identifier set, and serializes this structure into a format suitable for network transmission.
The server outputs a response payload that can be rendered by the terminal, with compact identifier sets included for each item.

### Step 14:

The terminal renders the received items and identifiers for the user.
The terminal takes, as input, the response payload from the server received over the communication interface.
The terminal deserializes the payload into in-memory objects, constructs user interface elements for each item (such as cards with title, snippet, and image thumbnail), and creates a selectable display element for each identifier, for example clickable tags aligned under each card.
The terminal outputs a visual display on the screen that shows items and their corresponding identifiers, allowing the user to see key features at a glance.

### Step 15:

The user interacts with identifiers to refine results.
The user observes the identifiers presented on the terminal and selects one or more identifiers that match the user's interest, by clicking or tapping the corresponding display elements.
The terminal captures, as input, the selection events generated by the user interaction and updates an internal list of selected identifiers; the terminal may visually highlight selected tags to provide feedback.
The terminal outputs an updated refinement request containing the selected identifiers as parameters and transmits this request to the server.

### Step 16:

The server executes refinement based on selected identifiers.
The server receives, as input, the refinement request from the terminal including the list of selected identifiers.
The server formulates a second retrieval query targeting the identifier set indices in the retrieval device, applying conditions that require or boost records containing the selected identifiers, and executes this query to obtain a filtered and re-ranked set of records.
The server outputs refined records that more closely match the selected identifiers and packages them into a new response payload.

### Step 17:

The terminal updates the display with refined items.
The terminal takes, as input, the refined response payload from the server.
The terminal replaces or augments the existing item list on the display by reconstructing user interface elements only for the refined records, and maintains the visual indication of which identifiers are currently active filters.
The terminal outputs an updated screen that shows a narrowed set of items aligned with the user's selected identifiers.

### Step 18:

The terminal acquires behavior information and biometric information for emotion estimation (optional).
The user continues to browse items, and the terminal records, as input, behavior information such as scrolling patterns, dwell time on items, and sequence of identifier selections; when permitted, the terminal may also capture facial images via the camera.
The terminal aggregates and, when necessary, anonymizes these data, and optionally compresses images or extracts facial feature vectors using an on-device image library.
The terminal outputs behavior and biometric information packets to the server for emotion estimation.

### Step 19:

The server estimates an emotion state and adjusts recommendations.
The server receives, as input, the behavior and biometric information from Step 18.
The server applies emotion analysis processing, using a classifier that converts feature vectors and interaction statistics into an emotion state label; then the server incorporates this emotion state into either a prompt sentence for an additional generative AI model call or into a ranking algorithm that prioritizes items associated with identifiers historically preferred under similar emotion conditions.
The server outputs adjusted recommendation records and associated identifier sets that reflect both the user's selected identifiers and the estimated emotion state.

### Step 20:

The terminal presents emotion-adapted recommendations to the user.
The terminal takes, as input, the adjusted recommendation records and identifier sets from the server.
The terminal renders an additional section of the user interface labeled as recommended items, showing titles, images, and identifiers for these items, and may visually distinguish them from the main search results.
The terminal outputs a combined display where the user can continue to select identifiers, refine results, and interact with items, thus closing the loop for subsequent iterations of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

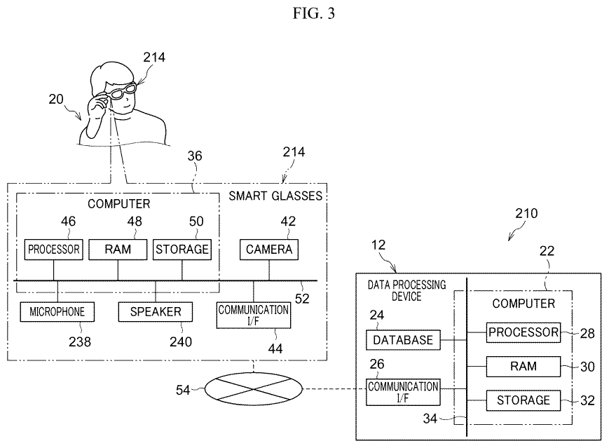

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

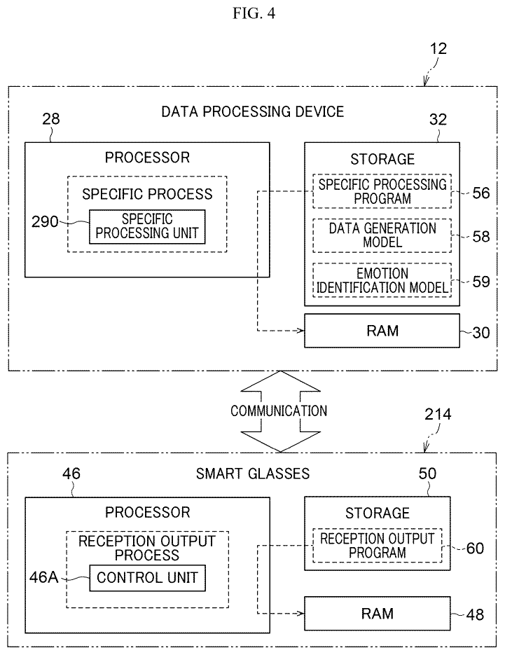

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

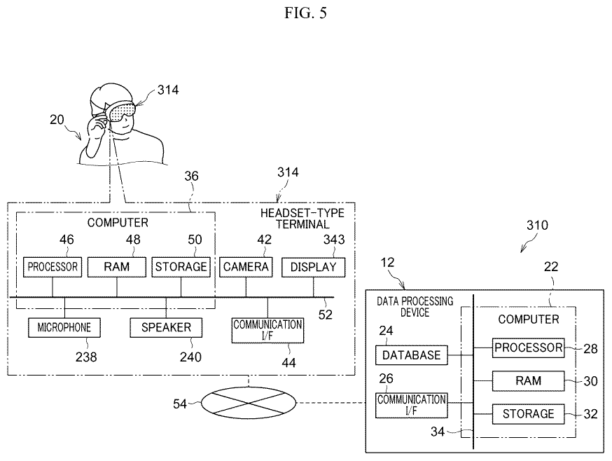

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

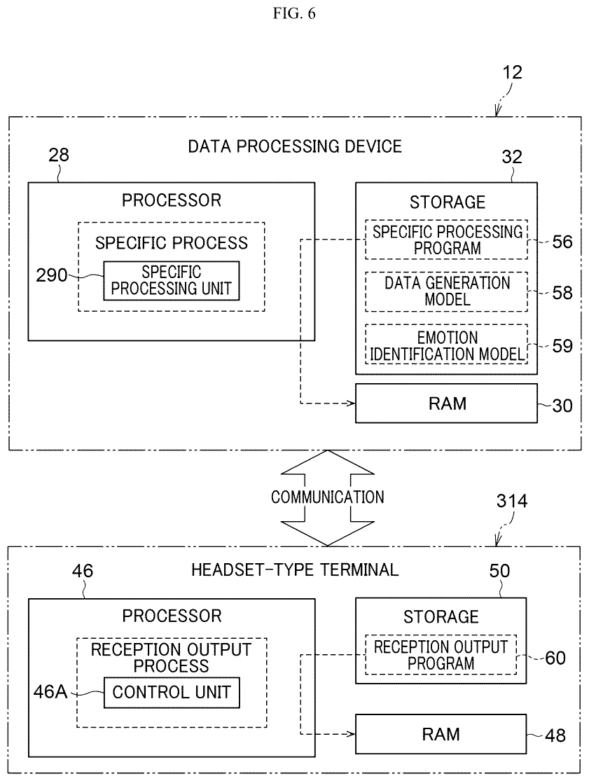

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

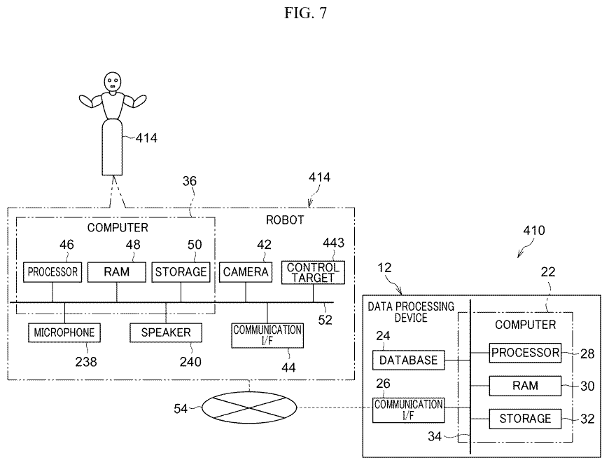

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

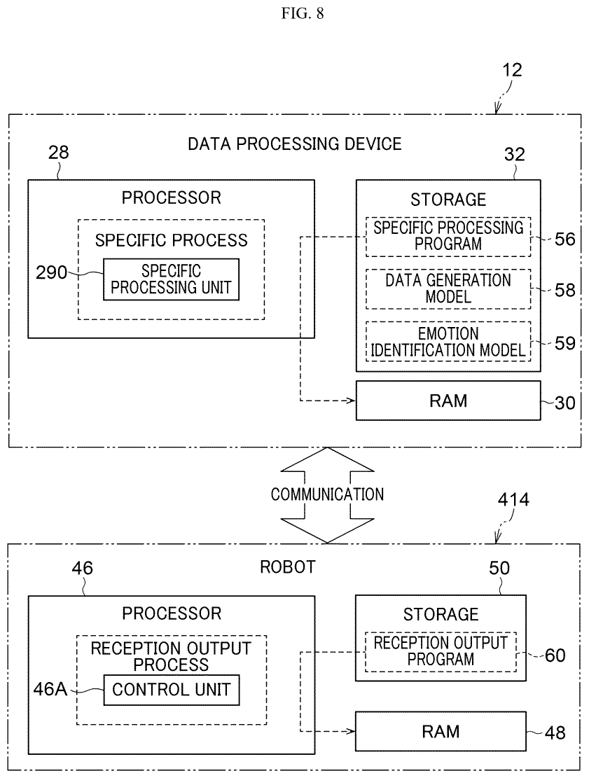

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

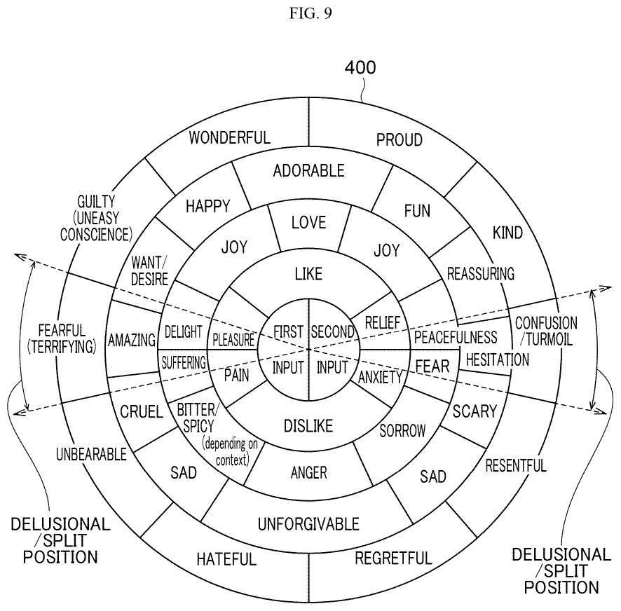

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

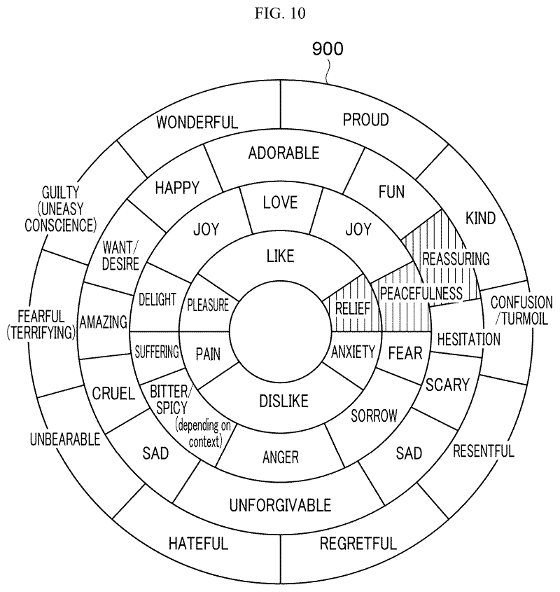

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a user terminal via a communication network, a search request and transmit the search request to an external information retrieval mechanism for search processing so as to obtain candidate information sources related to the search request,
obtain document data corresponding to the candidate information sources from the external information retrieval mechanism or from the respective information sources, and analyze structured documents included in the document data to extract main text information, perform preprocessing on the extracted text information, the preprocessing including character normalization and trimming based on a length limit, and generate a prompt sentence for inputting the preprocessed text information to a generative artificial intelligence model for natural language processing,
input the generated prompt sentence and the preprocessed text information to the generative artificial intelligence model, and obtain a summary or important information of the text information by language model processing including tokenization and an attention mechanism,
extract, based on the summary or important information obtained from the generative artificial intelligence model, a plurality of terms or term sequences, convert the terms or term sequences by format conversion into an array of identifiers as labels, and arrange the array of identifiers by duplicate elimination and limitation on a number of identifiers,
generate structured data by associating the arranged identifiers with each of the candidate information sources, and transmit the structured data as search results to the user terminal, and
cause, by transmitting display control information to the user terminal, titles, summary information, and the identifiers included in the structured data to be displayable on the user terminal, and to allow narrowing of the search results or transition to one of the information sources based on a selection operation on at least one of the identifiers.

### Supplementary 2

The system according to supplementary 1,
wherein the processor is configured to
generate the prompt sentence as a natural language instruction sentence that instructs the generative artificial intelligence model, based on the preprocessed text information including product-related data, character information, and image-related information contained in the information sources, to extract important terms and output the important terms as the identifiers, and to output the identifiers in a visually recognizable label format.

### Supplementary 3

The system according to supplementary 1,
wherein the processor is configured to
generate the prompt sentence as a natural language instruction sentence that instructs the generative artificial intelligence model to generate, based on analyzed contents of the information sources, labels or short sentences for proposing to a user highly relevant additional information, candidate products, or related information sources, and to transmit the generated labels or short sentences to the user terminal in association with the identifiers.

### Application Example 1

### Supplementary 1

A system comprising a processor,
wherein the processor is configured to
receive a search request from a user via a terminal, collect, on the basis of the search request, information sources from an information storage medium, the information sources including description information and evaluation information relating to an item,
extract character information from the collected information sources and perform natural language processing including morphological analysis, normalization of word forms, and removal of non-informative terms by using a natural language processing program so as to extract, on the basis of importance, phrases representing features,
generate a prompt sentence to be input to a generative AI model on the basis of the extracted phrases, and transmit the prompt sentence to the generative AI model,
obtain identifier candidates generated by the generative AI model in response to the prompt sentence, and normalize the identifier candidates into a predetermined format to determine identifiers representing features of the item, and
associate the determined identifiers with item information corresponding to the search request, transmit the item information and the determined identifiers to the terminal, and cause the terminal to display the item information together with the determined identifiers.

### Supplementary 2

The system according to supplementary 1,
wherein the processor is configured to cause the natural language processing program to calculate occurrence frequency and importance of phrases in the description information and the evaluation information by using a statistical method or a machine learning method, and select, on the basis of a calculation result, the phrases representing the features.

### Supplementary 3

The system according to supplementary 1,
wherein the processor is configured to generate the prompt sentence such that the prompt sentence includes at least one of the phrases representing the features or a part of the description information and the evaluation information, and includes an instruction that the generative AI model generate only a predetermined number of short identifiers in a predetermined language.

### Example 2

### Supplementary 1

A system comprising a processor,
wherein the processor is configured to
receive, from a user terminal, a search request including a search condition,
acquire, from an information storage device, structured information and unstructured information based on the search condition, and perform preprocessing on the acquired information to generate input data to be provided to a generative AI model,
generate, for the input data, a prompt sentence including an instruction for processing by the generative AI model and the input data, and transmit a request including the prompt sentence to the generative AI model via a communication interface,
receive, from the generative AI model, natural language text output as an analysis result of the input data, extract important expressions from the natural language text, normalize the important expressions as a group of identifiers representing features of the information, and store the group of identifiers in association with corresponding information items in the information storage device,
aggregate the group of identifiers for each product or information item, transmit the aggregated group of identifiers to the user terminal, and cause the user terminal to visually present the group of identifiers as selectable display elements,
and receive, from the user terminal, a refinement request including at least one identifier selected by a user from the group of identifiers, execute a search process on the information storage device based on the selected at least one identifier to extract information items associated with the selected at least one identifier, and transmit a search result to the user terminal.

### Supplementary 2

The system according to supplementary 1,
wherein the processor is configured to
dynamically generate the prompt sentence so as to specify processing content and an output format for causing the generative AI model to generate the identifiers, with respect to at least one information medium including character information and image information contained in the input data, and to cause the identifiers generated based on the prompt sentence to be displayed on the user terminal as display elements operable as search conditions.

### Supplementary 3

The system according to supplementary 1,
wherein the processor is configured to
transmit, to the generative AI model, an additional prompt sentence including the group of identifiers and the search condition, cause the generative AI model to estimate information items or additional identifiers having a relevance to the group of identifiers, and transmit an estimation result to the user terminal so as to propose related information or additional refinement candidates to the user.

### Application Example 2

### Supplementary 1

A system comprising a processor,
wherein the processor is configured to
receive, from a user terminal, a search request or imaging data and acquire, from a storage device or a retrieval device, related information based on the search request,
preprocess character information and image information included in the acquired information to generate analysis target data,
generate a prompt sentence including the analysis target data and input the prompt sentence to a generative AI model in order to obtain response data including a summary and feature terms of the information,
extract a plurality of identifier candidates from the response data and generate, by linguistic analysis processing and image analysis processing, an identifier set representing features of the information or item information by normalizing and integrating the identifier candidates, store the identifier set as structured data in association with a title, a description sentence, and an image of the information or the item information,
transmit the structured data including the identifier set to the user terminal and cause the user terminal to present the identifiers as selectable display elements, and
receive, from the user terminal, a refinement request based on selected identifiers and extract, based on the identifier set, related information or item information and transmit a refined search result to the user terminal.

### Supplementary 2

The system according to supplementary 1,
wherein the processor is configured to
input image data acquired from the user terminal to an image processing unit to extract visual feature information, and include the visual feature information in the prompt sentence input to the generative AI model so as to assign identifiers related to the image data to the identifier set.

### Supplementary 3

The system according to supplementary 1,
wherein the processor is configured to
execute emotion estimation processing by using emotion analysis processing based on behavior information or biometric information acquired from the user terminal, input a prompt sentence including an emotion state estimated by the emotion analysis processing to the generative AI model to cause the generative AI model to generate proposal content of related information, and present, to the user terminal, individualized related information based on the emotion state and the identifier set.

What is claimed is:

1. A system comprising:
circuitry configured to:
receive, from a terminal device via a packet-switched network, a search request including at least one query element;
obtain, based on the search request, candidate information sources from an information retrieval mechanism, acquire document data corresponding to the candidate information sources, and extract text information from structured documents included in the document data;
perform preprocessing on the extracted text information including character normalization and length-based trimming, and generate a prompt sentence for a generative neural network model by combining a predefined instruction template with the preprocessed text information;
input the prompt sentence and the preprocessed text information to the generative neural network model and obtain, by language model processing including tokenization and an attention mechanism, output data including at least one of a summary or important information derived from the text information;
extract, from the output data, a plurality of terms, convert the terms by format conversion into an array of identifiers, and arrange the array of identifiers by performing duplicate elimination and limiting a number of identifiers per information source; and
generate structured data by associating the arranged identifiers with each of the candidate information sources, and transmit the structured data together with display control information to the terminal device via the packet-switched network so as to cause the terminal device to render the identifiers as selectable display elements.

2. The system according to claim 1, wherein the circuitry is configured to parse each structured document by constructing a document object model, removing elements corresponding to navigation, style definitions, and scripts by filtering on tag types and attributes, and concatenating text from content nodes to produce the text information.

3. The system according to claim 2, wherein the circuitry is configured to compute an approximate token count of the text information and discard trailing segments when the token count exceeds a configurable threshold corresponding to a token capacity of the generative neural network model.

4. The system according to claim 3, wherein the circuitry is configured to convert full-width characters to half-width characters, unify different quotation mark representations, and remove non-printable control characters as part of the character normalization.

5. The system according to claim 4, wherein the prompt sentence instructs the generative neural network model to extract a predetermined number of important terms and output the terms as identifiers in a label format including a prefix character, and wherein the prompt sentence prohibits explanatory sentences in the output.

6. The system according to claim 5, wherein each identifier in the array begins with a hash prefix, internal spaces are replaced with underscores, and each identifier is converted to a standardized character case.

7. The system according to claim 1, wherein the generative neural network model comprises a transformer architecture including an embedding layer, a plurality of attention-based layers computing context-aware representations via multi-head self-attention and feed-forward sublayers, and an output layer producing a probability distribution over a vocabulary.

8. The system according to claim 7, wherein the circuitry is configured to set inference parameters including a temperature value, a sampling threshold, and a maximum number of output tokens so as to bias the generative neural network model toward deterministic and concise output sequences.

9. The system according to claim 8, wherein the circuitry is configured to apply constrained decoding in which only tokens satisfying a predetermined pattern including the prefix character are permitted at designated positions in the output sequence.

10. The system according to claim 9, wherein the generative neural network model is pre-trained on a corpus of text using an unsupervised language modeling objective and fine-tuned on task-specific data containing pairs of input documents and desired identifiers, the fine-tuning minimizing a cross-entropy loss between predicted token sequences and ground-truth identifier sequences.

11. The system according to claim 1, wherein the circuitry is configured to maintain an in-memory index that maps each identifier to a list of information source references, and upon receiving from the terminal device via the packet-switched network a refinement signal specifying a selected identifier, retrieve from the index a reduced set of candidate information sources associated with the selected identifier.

12. The system according to claim 11, wherein the circuitry is configured to transmit the reduced set to the terminal device without re-executing a full-text search against the information retrieval mechanism, thereby performing the refinement by index lookup.

13. The system according to claim 12, wherein the circuitry is configured to compare identifiers in a normalized form and discard entries that differ only by character case or minor punctuation variations during the duplicate elimination.

14. The system according to claim 1, wherein the circuitry is configured to receive, from the terminal device, description information and evaluation information relating to an item, execute a natural language processing program to perform morphological analysis, normalization of word forms, and removal of non-informative terms so as to extract phrases representing features from the description information and the evaluation information, and incorporate at least one of the extracted phrases into the prompt sentence.

15. The system according to claim 14, wherein the circuitry is configured to compute an importance score for each extracted phrase by calculating a term-frequency inverse-document-frequency value and select top-ranked phrases according to the importance score for inclusion in the prompt sentence.

16. The system according to claim 1, wherein the circuitry is configured to input image data associated with the candidate information sources to an image analysis network to extract visual feature information including at least one of object type or dominant color, and include identifiers derived from the visual feature information in the array of identifiers.

17. The system according to claim 16, wherein the circuitry is configured to execute emotion estimation processing based on at least one of behavior information or biometric information acquired from the terminal device, and incorporate an emotion state estimated by the emotion estimation processing into an additional prompt sentence input to the generative neural network model so as to generate proposal content of related information.

18. A system comprising:
circuitry configured to:
receive, from a terminal device via a packet-switched network, a search request including a query string;
transmit the query string to an external information retrieval mechanism and obtain a list of candidate information sources each represented by at least a uniform resource locator and a title;
retrieve document data from the candidate information sources by issuing retrieval requests via the packet-switched network, parse structured documents in the document data by constructing a document object model and removing non-content elements, and extract main text information from content nodes;
perform character normalization including unification of character encodings, normalization of punctuation, and normalization of whitespace on the main text information, and perform length-based trimming by discarding text segments exceeding a predetermined token limit;
generate a prompt sentence by inserting the preprocessed text information into a natural language instruction template that specifies a target number of identifiers and an output format constraint prohibiting explanatory sentences;
input the prompt sentence to a generative neural network model comprising a transformer architecture with multi-head self-attention layers and obtain a generated text sequence containing candidate identifiers;
parse the generated text sequence into individual candidate identifiers by splitting on delimiters, normalize each candidate identifier by applying case conversion and space-to-underscore replacement, perform duplicate elimination, and limit a total count of identifiers to a predetermined maximum to produce a finalized array of identifiers; and
generate structured data associating the finalized array of identifiers with metadata of each candidate information source including the title and a summary snippet, and transmit the structured data via the packet-switched network to the terminal device together with display control information specifying that the identifiers are to be rendered as selectable labels.

19. The system according to claim 18, wherein the circuitry is configured to receive, from the terminal device via the packet-switched network, a refinement request specifying a selected identifier, access an index that maps identifiers to information source references, and transmit to the terminal device a filtered subset of the candidate information sources associated with the selected identifier.

20. A method comprising:
receiving, by circuitry from a terminal device via a packet-switched network, a search request including at least one query element;
obtaining, based on the search request, candidate information sources from an information retrieval mechanism, acquiring document data corresponding to the candidate information sources, and extracting text information from structured documents included in the document data;
performing preprocessing on the extracted text information including character normalization and length-based trimming, and generating a prompt sentence for a generative neural network model by combining a predefined instruction template with the preprocessed text information;
inputting the prompt sentence and the preprocessed text information to the generative neural network model and obtaining, by language model processing including tokenization and an attention mechanism, output data including at least one of a summary or important information derived from the text information;
extracting, from the output data, a plurality of terms, converting the terms by format conversion into an array of identifiers, and arranging the array of identifiers by performing duplicate elimination and limiting a number of identifiers per information source; and
generating structured data by associating the arranged identifiers with each of the candidate information sources, and transmitting the structured data together with display control information to the terminal device via the packet-switched network so as to cause the terminal device to render the identifiers as selectable display elements.
